(19) United States
(12) Patent Application Publication
(10) Pub. No.: US 2026/0260037 A1
(43) Pub. Date: Sep. 3, 2026

(54) SYSTEMS, APPARATUSES, CONTROLLERS, AND METHODS PROVIDING ENHANCED FATIGUE STRENGTH ANALYSIS

(71) Applicant: Vulcan Industrial Holdings, LLC, Houston, TX (US)

(72) Inventor: Benjamin Berryhill, Houston, TX (US)

(21) Appl. No.: 19/149,233

(22) PCT Filed: Sep. 5, 2023
(86) PCT No.: PCT/US2023/073458

§ 371 Date: Jul. 18, 2025

Related U.S. Application Data
(60) Provisional application No. 63/443,351, filed on Feb. 3, 2023.
(60) Provisional application No. 63/492,064, filed on Mar. 24, 2023.

(51) Int. Cl. G06F 30/23; G06F 30/18; G06F 111/10; G06F 119/04; G06F 119/14

(52) U.S. Cl. CPC G06F 30/23; G06F 30/18; G06F 2111/10; G06F 2119/04; G06F 2119/14

(57) ABSTRACT

Systems, apparatuses, controllers, and methods may provide enhanced fatigue strength analysis by providing accurate and coordinate system invariant results. First and second localized load measure tensors associated with first and second instants in time and a component may include first, second, and third tensor invariants. The third tensor invariant may be non-collinear relative to the first tensor invariant or the second tensor invariant, and the first and second localized load measure tensors may be determined at an orientation relative to a coordinate system. First, second, and third fatigue strengths having respective load ratios and lives associated with the component may be used to determine an equivalent localized load measure associated with the component.

### CROSS REFERENCE TO RELATED APPLICATIONS

This application is a PCT of U.S. Provisional Application No. 63/443,351, filed Feb. 3, 2023, titled “SYSTEMS, APPARATUSES, CONTROLLERS, AND METHODS PROVIDING ENHANCED FATIGUE STRENGTH ANALYSIS,” and U.S. Provisional Application No. 63/492,064, filed Mar. 24, 2023, titled “SYSTEMS, APPARATUSES, CONTROLLERS, AND METHODS PROVIDING ENHANCED FATIGUE STRENGTH ANALYSIS,” the disclosures of all of which are incorporated herein by reference in their entireties.

### TECHNICAL FIELD

The present disclosure relates to systems, apparatuses, controllers, and methods providing enhanced fatigue strength analysis and, more particularly, to systems, apparatuses, controllers, and methods providing enhanced fatigue strength analysis for components subjected to cyclic loading.

### BACKGROUND

Mechanical components of machines are often subjected to cyclic loading. In some instances, cyclic loading presents a relatively greater likelihood of component failure than other failure modes, such as static failure modes. For example, many mechanical components are subjected to cyclic loading, and fatigue is the initiation and propagation of cracks in a material due to cyclic loading. Analytical fatigue models have been developed to predict the fatigue strength, or the stress at which the component would be expected on average to endure for a specified number of load cycles, and the fatigue limit, or the stress below which failure due to cyclic loading would not be expected. The fatigue limit of a component formed from a given material is the magnitude of cyclic loading or stress below which the component would not be expected to ever fail due to the cyclic loading. Fatigue models have been developed for the analysis of fatigue to assist with the design of mechanical components. A goal of fatigue models is to provide an analytical or computational method to predict (a) the number of loading cycles of a given magnitude to failure for the component formed from a given material, or (b) the fatigue limit of a given component formed from a given material, each without the need to build a physical prototype of the component and subject the prototype to actual cyclic loading tests.

Many fatigue models require the selection of a coordinate system for evaluation of the fatigue strength of a component. Although a coordinate system may often be required, the selection of the coordinate system and/or the orientation of the component relative to the coordinate system may be arbitrary. It may often be important for a component designer to be able to select different coordinate system orientations when evaluating a component design, and thus, the ability for an analytical fatigue model to yield accurate results, regardless of the coordinate system and/or the orientation of the component relative to the coordinate system may be an important characteristic of the model. As explained herein, some analytical fatigue models, although generally accurate for a particular choice of coordinate system, may not yield consistent results for different orientations. For example, some such analytical fatigue models may yield different fatigue strength results, depending on the orientation of the coordinate system, thus rendering the analytical model less useful.

Other analytical fatigue strength models, while generally yielding relatively accurate results, may be computationally complex, may present an inefficient use of computer resources, and/or may be financially inefficient or cost-prohibitive. For example, many critical-plane-based fatigue strength models and integral-based fatigue strength methods, while relatively accurate for many fatigue strength evaluations, may often use complex algorithms to iteratively calculate results. Such complex algorithms and iterative calculations may result in a significant use of computer resources, often requiring hundreds or even thousands of calculations to reach a solution. In addition, many such fatigue strength methods, due to the complex nature of the calculations, require dedicated software for operation, adding to costs associated with using critical-plane-based and integral-based fatigue strength analysis methods.

For at least these reasons, Applicant has recognized that it may be desirable to provide systems, apparatuses, controllers, and methods for providing an enhanced fatigue strength analysis that address one or more of the above-noted potential issues with known fatigue analysis methods, as well as potentially others.

### SUMMARY

As referenced above, it may be desirable to provide systems, apparatuses, controllers, and methods for providing an enhanced fatigue strength analysis that yield consistent results, regardless of the coordinate system or orientation, that provide accurate fatigue strength predictions, and/or that consume fewer computer resources relative to more complex fatigue analysis methods, such as critical-plane-based methods and integral-based methods. For example, in some embodiments, the systems, apparatuses, controllers, and methods presented herein may provide a fatigue strength analysis that is coordinate system invariant and, in many instances, is generally as accurate or more accurate than more computationally complex critical-plane-based methods and/or integral-based methods. For example, in some embodiments, systems, apparatuses, controllers, and methods presented herein for fatigue strength analysis may be computationally less complex than many other fatigue models, and thus, may be executed in spreadsheet software, and, in some instances, without using macros. This may result in a substantial improvement in computational efficiency compared to other models that require substantial computing power to reach solutions of comparable accuracy, such as critical-plane-based methods and integral-based methods.

According to some embodiments, a method to enhance prediction of fatigue strength associated with a component may include determining a fully reversed tension fatigue strength, a fully reversed torsion fatigue strength, a repeated tension fatigue strength, and a repeated torsion fatigue strength. The method further may include determining material parameters associated with the component, based in at least in part on the fully reversed tension fatigue strength, the fully reversed torsion fatigue strength, the repeated tension fatigue strength, and the repeated torsion fatigue strength. The method also may include determining a first localized load measure tensor associated with a first fatigue-relevant instant in time and a portion of the component. The method further may include determining a second localized load measure tensor associated with a second fatigue-relevant instant in time and the portion of the component, the first localized load measure tensor and the second localized load measure tensor being determined at an orientation relative to a coordinate system. The method also may include determining, based at least in part on the first localized load measure tensor and the second localized load measure tensor, an equivalent mean localized load measure tensor. The method further may include determining, based at least in part on the first localized load measure tensor and the second localized load measure tensor, an equivalent alternating localized load measure tensor. The method also may include determining, based at least in part on the equivalent mean localized load measure tensor, the equivalent alternating localized load measure tensor, and the material parameters, an equivalent mean octahedral shear localized load measure. The method further may include determining, based at least in part on the equivalent mean localized load measure tensor, the equivalent alternating localized load measure tensor, and the material parameters, an equivalent alternating octahedral shear localized load measure. The method also may include determining, based at least in part on the equivalent mean localized load measure tensor, the equivalent alternating localized load measure tensor, and the material parameters, an equivalent mean hydrostatic localized load measure. The method further may include determining, based at least in part on the equivalent mean localized load measure tensor, the equivalent alternating localized load measure tensor, and the material parameters, an equivalent alternating hydrostatic localized load measure. The method also may include determining, via a fatigue strength analyzer and based at least in part on: (a) the equivalent mean octahedral localized load measure, (b) the equivalent alternating octahedral localized load measure, (c) the equivalent mean hydrostatic localized load measure, and (d) the equivalent alternating hydrostatic localized load measure, an equivalent localized load measure associated with the portion of the component, such that the equivalent localized load measure is substantially independent of the orientation relative to the coordinate system.

According to some embodiments, a method to enhance prediction of fatigue strength associated with a component may include determining a first localized load measure tensor associated with a first fatigue-relevant instant in time and a portion of the component, the first localized load measure tensor having a first tensor invariant. The method further may include determining a second localized load measure tensor associated with a second fatigue-relevant instant in time and the portion of the component. The second localized load measure tensor may have a second tensor invariant, and one of the first localized load measure tensor or the second localized load measure tensor may have a third tensor invariant. The third tensor invariant may be non-collinear relative to one of the first tensor invariant or the second tensor invariant of the one of the first localized load measure tensor or the second localized load measure tensor. The first localized load measure tensor and the second localized load measure tensor may be determined at an orientation relative to a coordinate system. The method further may include determining a first fatigue strength, the first fatigue strength being a single-load-mode fatigue strength and having a first loading mode, a first load ratio, and a first life associated with the portion of the component. The method also may include determining a second fatigue strength, the second fatigue strength being a single-load-mode fatigue strength and having a second loading mode, a second load ratio, and second life associated with the portion of the component. The method further may include determining a third fatigue strength, the third fatigue strength being a single-load-mode fatigue strength and having a third loading mode, a third load ratio, and a third life associated with the portion of the component. The method also may include determining, via a fatigue strength analyzer and based at least in part on the first tensor invariant, the second tensor invariant, the third tensor invariant, the first fatigue strength, the second fatigue strength, and the third fatigue strength, an equivalent localized load measure associated with the portion of the component, such that the equivalent localized load measure is substantially independent of the orientation relative to the coordinate system.

According to some embodiments, a method to enhance design of a component may include specifying a geometry of a component, specifying a material of the component, and specifying a cyclic load to which the component is to be subjected. The method further may include determining a fully reversed tension fatigue strength, a fully reversed torsion fatigue strength, a repeated tension fatigue strength, and a repeated torsion fatigue strength. The method also may include determining material parameters associated with the component, based in at least in part on the fully reversed tension fatigue strength, the fully reversed torsion fatigue strength, the repeated tension fatigue strength, and the repeated torsion fatigue strength. The method further may include determining, based at least in part on the geometry of the component and the cyclic load, a first localized load measure tensor associated with a first fatigue-relevant instant in time and a portion of the component. The method also may include determining, based at least in part on the geometry and the cyclic load, a second localized load measure tensor associated with a second fatigue-relevant instant in time and the portion of the component, the first localized load measure tensor and the second localized load measure tensor being determined at an orientation relative to a coordinate system. The method further may include determining, based at least in part on the first localized load measure tensor and the second localized load measure tensor, an equivalent mean localized load measure tensor. The method also may include determining, based at least in part on the first localized load measure tensor and the second localized load measure tensor, an equivalent alternating localized load measure tensor. The method also may include determining, based at least in part on the equivalent mean localized load measure tensor, the equivalent alternating localized load measure tensor, and the material parameters, an equivalent mean octahedral shear localized load measure. The method further may include determining, based at least in part on the equivalent mean localized load measure tensor, the equivalent alternating localized load measure tensor, and the material parameters, an equivalent alternating octahedral shear localized load measure. The method also may include determining, based at least in part on the equivalent mean localized load measure tensor, the equivalent alternating localized load measure tensor, and the material parameters, an equivalent mean hydrostatic localized load measure. The method further may include determining, based at least in part on the equivalent mean localized load measure tensor, the equivalent alternating localized load measure tensor, and the material parameters, an equivalent alternating hydrostatic localized load measure. The method also may include determining, via a fatigue strength analyzer and based at least in part on: (a) the equivalent mean octahedral localized load measure, (b) the equivalent alternating octahedral localized load measure, (c) the equivalent mean hydrostatic localized load measure, and (d) the equivalent alternating hydrostatic localized load measure, an equivalent localized load measure associated with the portion of the component, such that the equivalent localized load measure is substantially independent of the orientation relative to the coordinate system.

According to some embodiments, a method to enhance design of a component may include specifying a geometry of a component, specifying a material of the component, and specifying a cyclic load to which the component is to be subjected. The method further may include determining, based at least in part on the geometry of the component and the cyclic load, a first localized load measure tensor associated with a first fatigue-relevant instant in time and a portion of the component, the first localized load measure tensor having a first tensor invariant. The method also may include determining, based at least in part on the geometry and the cyclic load, a second localized load measure tensor associated with a second fatigue-relevant instant in time and the portion of the component, the second localized load measure tensor having a second tensor invariant. One of the first localized load measure tensor or the second localized load measure tensor may have a third tensor invariant, and the third tensor invariant may be non-collinear relative to one of the first tensor invariant or the second tensor invariant of the one of the first localized load measure tensor or the second localized load measure tensor. The first localized load measure tensor and the second localized load measure tensor may be determined at an orientation relative to a coordinate system. The method further may include determining a first fatigue strength, the first fatigue strength being a single-load-mode fatigue strength and having a first loading mode, a first load ratio, and a first life associated with the portion of the component. The method also may include determining a second fatigue strength, the second fatigue strength being a single-load-mode fatigue strength and having a second loading mode, a second load ratio, and second life associated with the portion of the component. The method further may include determining a third fatigue strength, the third fatigue strength being a single-load-mode fatigue strength and having a third loading mode, a third load ratio, and a third life associated with the portion of the component. The method also may include determining, via a fatigue strength analyzer and based at least in part on the first tensor invariant, the second tensor invariant, the third tensor invariant, the first fatigue strength, the second fatigue strength, and the third fatigue strength, an equivalent localized load measure associated with the portion of the component, such that the equivalent localized load measure is substantially independent of the orientation relative to the coordinate system.

According to some embodiments, a fatigue strength analyzer for enhancing prediction of a fatigue strength associated with a component may include a fatigue controller configured to receive a signal indicative of a fully reversed tension fatigue strength, a signal indicative of a fully reversed torsion fatigue strength, a signal indicative of a repeated tension fatigue strength, a signal indicative of a repeated torsion fatigue strength, and a signal indicative of material parameters associated with the component. The fatigue controller may further be configured to receive a first localized load measure tensor signal indicative of a first localized load measure tensor associated with a first fatigue-relevant instant in time and a portion of the component, and receive a second localized load measure tensor signal indicative of a second localized load measure tensor associated with a second fatigue-relevant instant in time and the portion of the component. The first localized load measure tensor and the second localized load measure tensor may be determined at an orientation relative to a coordinate system. The fatigue controller further may be configured to determine, based at least in part on the first localized load measure tensor and the second localized load measure tensor, an equivalent mean localized load measure tensor. The fatigue controller also may be configured to determine, based at least in part on the first localized load measure tensor and the second localized load measure tensor, an equivalent alternating localized load measure tensor. The fatigue controller further may be configured to determine, based at least in part on the equivalent mean localized load measure tensor, the equivalent alternating localized load measure tensor, and the material parameters, an equivalent mean octahedral shear localized load measure. The fatigue controller also may be configured to determine, based at least in part on the equivalent mean localized load measure tensor, the equivalent alternating localized load measure tensor, and the material parameters, an equivalent alternating octahedral shear localized load measure. The fatigue controller further may be configured to determine, based at least in part on the equivalent mean localized load measure tensor, the equivalent alternating localized load measure tensor, and the material parameters, an equivalent mean hydrostatic localized load measure. The fatigue controller also may be configured to determine, based at least in part on the equivalent mean localized load measure tensor, the equivalent alternating localized load measure tensor, and the material parameters, an equivalent alternating hydrostatic localized load measure. The fatigue controller further may be configured to determine, based at least in part on: (a) the equivalent mean octahedral localized load measure, (b) the equivalent alternating octahedral localized load measure, (c) the equivalent mean hydrostatic localized load measure, and (d) the equivalent alternating hydrostatic localized load measure, such that the equivalent localized load measure is substantially independent of the orientation relative to the coordinate system.

According to some embodiments, a fatigue strength analyzer for enhancing prediction of a fatigue strength associated with a component may include a fatigue controller configured to receive a first localized load measure tensor signal indicative of a first localized load measure tensor associated with a first fatigue-relevant instant in time and a portion of the component. The first localized load measure tensor may have a first tensor invariant. The fatigue controller further may be configured to receive a second localized load measure tensor signal indicative of a second localized load measure tensor associated with a second fatigue-relevant instant in time and the portion of the component. The second localized load measure tensor may have a second tensor invariant, and one of the first localized load measure tensor or the second localized load measure tensor may have a third tensor invariant. The third tensor invariant may be non-collinear relative to one of the first tensor invariant or the second tensor invariant of the one of the first localized load measure tensor or the second localized load measure tensor, and the first localized load measure tensor and the second localized load measure tensor being determined at an orientation relative to a coordinate system. The fatigue controller further may be configured to determine a first fatigue strength, the first fatigue strength being a single-load-mode fatigue strength and having a first loading mode, a first load ratio, and a first life associated with the portion of the component. The fatigue controller also may be configured to determine a second fatigue strength, the second fatigue strength being a single-load-mode fatigue strength and having a second loading mode, a second load ratio, and second life associated with the portion of the component. The fatigue controller further may be configured to determine a third fatigue strength, the third fatigue strength being a single-load-mode fatigue strength and having a third loading mode, a third load ratio, and a third life associated with the portion of the component. The fatigue controller also may be configured to determine, based at least in part on the first tensor invariant, the second tensor invariant, the third tensor invariant, the first fatigue strength, the second fatigue strength, and the third fatigue strength, an equivalent localized load measure associated with the portion of the component, such that the equivalent localized load measure is substantially independent of the orientation relative to the coordinate system.

According to some embodiments, an oilfield operational component may include a component geometry and a component material having a material fatigue limit and forming the component geometry. The oilfield operational component may be configured such that when subjected to cyclic loading the oilfield operational component has an equivalent localized load measure less than or equal to the material fatigue limit. The equivalent localized load measure may be determined according to a fatigue strength model configured to receive a signal indicative of a fully reversed tension fatigue strength, a signal indicative of a fully reversed torsion fatigue strength, a signal indicative of a repeated tension fatigue strength, a signal indicative of a repeated torsion fatigue strength, and a signal indicative of material parameters associated with the component. The fatigue controller may further be configured to receive a first localized load measure tensor signal indicative of a first localized load measure tensor associated with a first fatigue-relevant instant in time and a portion of the component, and receive a second localized load measure tensor signal indicative of a second localized load measure tensor associated with a second fatigue-relevant instant in time and the portion of the component. The first localized load measure tensor and the second localized load measure tensor may be determined at an orientation relative to a coordinate system. The fatigue strength model further may be configured to determine, based at least in part on the first localized load measure tensor and the second localized load measure tensor, an equivalent mean localized load measure tensor, and an equivalent alternating localized load measure tensor. The fatigue strength model also may be configured to determine, based at least in part on the equivalent mean localized load measure tensor, the equivalent alternating localized load measure tensor, and the material parameters, an equivalent mean octahedral shear localized load measure and an equivalent alternating octahedral shear localized load measure. The fatigue strength model further may be configured to determine, based at least in part on the equivalent mean localized load measure tensor, the equivalent alternating localized load measure tensor, and the material parameters, an equivalent mean hydrostatic localized load measure and an equivalent alternating hydrostatic localized load measure. The fatigue strength model also may be configured to determine, based at least in part on: (a) the equivalent mean octahedral localized load measure, (b) the equivalent alternating octahedral localized load measure, (c) the equivalent mean hydrostatic localized load measure, and (d) the equivalent alternating hydrostatic localized load measure, an equivalent localized load measure associated with the portion of the component, such that the equivalent localized load measure is substantially independent of the orientation relative to the coordinate system.

According to some embodiments, an oilfield operational component may include a component geometry and a component material having a material fatigue limit and forming the component geometry. The oilfield operational component may be configured such that when subjected to cyclic loading the oilfield operational component has an equivalent localized load measure less than or equal to the material fatigue limit. The equivalent localized load measure may be determined according to a fatigue strength model configured to receive a first localized load measure tensor signal indicative of a first localized load measure tensor associated with a first fatigue-relevant instant in time and a portion of the component, the first localized load measure tensor having a first tensor invariant. The fatigue strength model also may be configured to receive a second localized load measure tensor signal indicative of a second localized load measure tensor associated with a second fatigue-relevant instant in time and the portion of the component, the second localized load measure tensor having a second tensor invariant. One of the first localized load measure tensor or the second localized load measure tensor may have a third tensor invariant, the third tensor invariant being non-collinear relative to one of the first tensor invariant or the second tensor invariant of the one of the first localized load measure tensor or the second localized load measure tensor. The first localized load measure tensor and the second localized load measure tensor may be determined at an orientation relative to a coordinate system. The fatigue strength model also may be configured to determine a first fatigue strength, the first fatigue strength being a single-load-mode fatigue strength and having a first loading mode, a first load ratio, and a first life associated with the portion of the component. The fatigue strength model further may be configured to determine a second fatigue strength, the second fatigue strength being a single-load-mode fatigue strength and having a second loading mode, a second load ratio, and second life associated with the portion of the component. The fatigue strength model also may be configured to determine a third fatigue strength, the third fatigue strength being a single-load-mode fatigue strength and having a third loading mode, a third load ratio, and a third life associated with the portion of the component. The fatigue strength model further may be configured to determine, based at least in part on the first tensor invariant, the second tensor invariant, the third tensor invariant, the first fatigue strength, the second fatigue strength, and the third fatigue strength, an equivalent localized load measure associated with the portion of the component, such that the equivalent localized load measure is substantially independent of the orientation relative to the coordinate system.

According to some embodiments, a method of enhancing manufacture of a component may include providing a geometry for the component. The method further may include determining a first fatigue strength, the first fatigue strength being a single-load-mode fatigue strength and having a first loading mode, a first load ratio, and a first life associated with the portion of the component. The method also may include determining a second fatigue strength, the second fatigue strength being a single-load-mode fatigue strength and having a second loading mode, a second load ratio, and second life associated with the portion of the component. The method further may include determining a third fatigue strength, the third fatigue strength being a single-load-mode fatigue strength and having a third loading mode, a third load ratio, and a third life associated with the portion of the component. The method also may include determining a material of the component, the material having a material fatigue strength. The method further may include determining a cyclic load to which the component is to be subjected. The method also may include determining, based at least in part on the geometry of the component and the cyclic load, a first localized load measure tensor associated with a first fatigue-relevant instant in time and a portion of the component, and a second localized load measure tensor associated with a second fatigue-relevant instant in time and the portion of the component. The first localized load measure tensor and the second localized load measure tensor may be determined at an orientation relative to a coordinate system. The method also may include determining, based at least in part on the first localized load measure tensor and the second localized load measure tensor, an equivalent mean localized load measure tensor and an equivalent alternating localized load measure tensor. The method further may include determining, based at least in part on the equivalent mean localized load measure tensor, the equivalent alternating localized load measure tensor, and material parameters associated with the material, an equivalent mean octahedral shear localized load measure and an equivalent alternating octahedral shear localized load measure. The method also may include determining, based at least in part on the equivalent mean localized load measure tensor, the equivalent alternating localized load measure tensor, and the material parameters, an equivalent mean hydrostatic localized load measure and an equivalent alternating hydrostatic localized load measure. The method further may include determining, based at least in part on: (a) the equivalent mean octahedral localized load measure, (b) the equivalent alternating octahedral localized load measure, (c) the equivalent mean hydrostatic localized load measure, and (d) the equivalent alternating hydrostatic localized load measure, an equivalent localized load measure associated with the portion of the component, such that the equivalent localized load measure is substantially independent of the orientation relative to the coordinate system. The method also may include, when the equivalent localized load measure is less than or equal to the material fatigue strength, forming the component according to the geometry of the component from the material of the component.

According to some embodiments, a method of enhancing manufacture of a component may include providing a geometry for the component and determining a material of the component, the material having a material fatigue strength. The method further may include determining a cyclic load to which the component is to be subjected. The method also may include determining a first localized load measure tensor associated with a first fatigue-relevant instant in time and a portion of the component, the first localized load measure tensor having a first tensor invariant. The method further may include determining a second localized load measure tensor associated with a second fatigue-relevant instant in time and the portion of the component, the second localized load measure tensor having a second tensor invariant. One of the first localized load measure tensor or the second localized load measure tensor may have a third tensor invariant, the third tensor invariant being non-collinear relative to one of the first tensor invariant or the second tensor invariant of the one of the first localized load measure tensor or the second localized load measure tensor. The first localized load measure tensor and the second localized load measure tensor may be determined at an orientation relative to a coordinate system. The method also may include determining a first fatigue strength, the first fatigue strength being a single-load-mode fatigue strength and having a first loading mode, a first load ratio, and a first life associated with the portion of the component. The method further may include determining a second fatigue strength, the second fatigue strength being a single-load-mode fatigue strength and having a second loading mode, a second load ratio, and second life associated with the portion of the component. The method also may include determining a third fatigue strength, the third fatigue strength being a single-load-mode fatigue strength and having a third loading mode, a third load ratio, and a third life associated with the portion of the component. The method further may include determining, via a fatigue strength analyzer and based at least in part on the first tensor invariant, the second tensor invariant, the third tensor invariant, the first fatigue strength, the second fatigue strength, and the third fatigue strength, an equivalent localized load measure associated with the portion of the component, such that the equivalent localized load measure is substantially independent of the orientation relative to the coordinate system. The method also may include, when the equivalent localized load measure is less than or equal to the material fatigue strength, forming the component according to the geometry of the component from the material of the component.

According to some embodiments, a method for enhancing simulation of effects of cyclic loading on a component having a component geometry and being formed from a component material having a material fatigue strength, may include providing a cyclic load to which the component is to be subjected during the simulation. The method further may include determining a first fatigue strength, the first fatigue strength being a single-load-mode fatigue strength and having a first loading mode, a first load ratio, and a first life associated with the portion of the component. The method also may include determining a second fatigue strength, the second fatigue strength being a single-load-mode fatigue strength and having a second loading mode, a second load ratio, and second life associated with the portion of the component. The method further may include determining a third fatigue strength, the third fatigue strength being a single-load-mode fatigue strength and having a third loading mode, a third load ratio, and a third life associated with the portion of the component. The method also may include determining, based at least in part on the geometry of the component and the cyclic load, a first localized load measure tensor associated with a first fatigue-relevant instant in time and a portion of the component. The method further may include determining, based at least in part on the geometry and the cyclic load, a second localized load measure tensor associated with a second fatigue-relevant instant in time and the portion of the component, the first localized load measure tensor and the second localized load measure tensor being determined at an orientation relative to a coordinate system. The method also may include determining, based at least in part on the first localized load measure tensor and the second localized load measure tensor, an equivalent mean localized load measure tensor and an equivalent alternating localized load measure tensor. The method further may include determining, based at least in part on the equivalent mean localized load measure tensor, the equivalent alternating localized load measure tensor, and the material parameters associated with the material, an equivalent mean octahedral shear localized load measure and an equivalent alternating octahedral shear localized load measure. The method also may include determining, based at least in part on the equivalent mean localized load measure tensor, the equivalent alternating localized load measure tensor, and the material parameters, an equivalent mean hydrostatic localized load measure and an equivalent alternating hydrostatic localized load measure. The method further may include determining, based at least in part on: (a) the equivalent mean octahedral localized load measure, (b) the equivalent alternating octahedral localized load measure, (c) the equivalent mean hydrostatic localized load measure, and (d) the equivalent alternating hydrostatic localized load measure, an equivalent localized load measure associated with the portion of the component, such that the equivalent localized load measure is substantially independent of the orientation relative to the coordinate system.

According to some embodiments, a method for enhancing simulation of effects of cyclic loading on a component having a component geometry and being formed from a component material having a material fatigue strength, may include providing a cyclic load to which the component is to be subjected during the simulation and determining, based at least in part on the geometry of the component and the cyclic load, a first localized load measure tensor associated with a first fatigue-relevant instant in time and a portion of the component, the first localized load measure tensor having a first tensor invariant. The method further may include determining a second localized load measure tensor associated with a second fatigue-relevant instant in time and the portion of the component, the second localized load measure tensor having a second tensor invariant. One of the first localized load measure tensor or the second localized load measure tensor may have a third tensor invariant, the third tensor invariant being non-collinear relative to one of the first tensor invariant or the second tensor invariant of the one of the first localized load measure tensor or the second localized load measure tensor, the first localized load measure tensor and the second localized load measure tensor being determined at an orientation relative to a coordinate system. The method also may include determining a first fatigue strength, the first fatigue strength being a single-load-mode fatigue strength and having a first loading mode, a first load ratio, and a first life associated with the component. The method further may include determining a second fatigue strength, the second fatigue strength being a single-load-mode fatigue strength and having a second loading mode, a second load ratio, and second life associated with the component. The method also may include determining a third fatigue strength, the third fatigue strength being a single-load-mode fatigue strength and having a third loading mode, a third load ratio, and a third life associated with the portion of the component. The method further may include determining, via a fatigue strength analyzer and based at least in part on the first tensor invariant, the second tensor invariant, the third tensor invariant, the first fatigue strength, the second fatigue strength, and the third fatigue strength, an equivalent localized load measure associated with the portion of the component, such that the equivalent localized load measure is substantially independent of the orientation relative to the coordinate system.

According to some embodiments, a computer-implemented method for enhanced prediction of fatigue strength associated with a component may include receiving in a fatigue strength model: (a) a first localized load measure tensor signal indicative of a first localized load measure tensor associated with a first fatigue-relevant instant in time and a portion of the component, and (b) a second localized load measure tensor signal indicative of a second localized load measure tensor associated with a second fatigue-relevant instant in time and the portion of the component. The first localized load measure tensor and the second localized load measure tensor may be determined at an orientation relative to a coordinate system. The fatigue strength model may be configured to determine, based at least in part on the first localized load measure tensor and the second localized load measure tensor, an equivalent mean localized load measure tensor and an equivalent alternating localized load measure tensor. The fatigue strength model further may be configured to determine, based at least in part on the equivalent mean localized load measure tensor, the equivalent alternating localized load measure tensor, and the material parameters associated with the material, an equivalent mean octahedral shear localized load measure and an equivalent alternating octahedral shear localized load measure. The fatigue strength model also may be configured to determine, based at least in part on the equivalent mean localized load measure tensor, the equivalent alternating localized load measure tensor, and the material parameters, an equivalent mean hydrostatic localized load measure and an equivalent alternating hydrostatic localized load measure. The fatigue strength model further may be configured to determine, based at least in part on: (a) the equivalent mean octahedral localized load measure, (b) the equivalent alternating octahedral localized load measure, (c) the equivalent mean hydrostatic localized load measure, and (d) the equivalent alternating hydrostatic localized load measure, an equivalent localized load measure associated with the portion of the component, such that the equivalent localized load measure is substantially independent of the orientation relative to the coordinate system.

According to some embodiments, a computer-implemented method for enhanced prediction of fatigue strength associated with a component may include receiving in a fatigue strength model: (a) a first localized load measure tensor signal indicative of a first localized load measure tensor associated with a first fatigue-relevant instant in time and a portion of the component, the first localized load measure tensor having a first tensor invariant; and (b) a second localized load measure tensor signal indicative of a second localized load measure tensor associated with a second fatigue-relevant instant in time and the portion of the component, the second localized load measure tensor having a second tensor invariant. One of the first localized load measure tensor or the second localized load measure tensor may have a third tensor invariant, the third tensor invariant being non-collinear relative to one of the first tensor invariant or the second tensor invariant of the one of the first localized load measure tensor or the second localized load measure tensor, and the first localized load measure tensor and the second localized load measure tensor may be determined at an orientation relative to a coordinate system. The fatigue strength model may be configured to determine a first fatigue strength, the first fatigue strength being a single-load-mode fatigue strength and having a first loading mode, a first load ratio, and a first life associated with the portion of the component. The fatigue strength model further may be configured to determine a second fatigue strength, the second fatigue strength being a single-load-mode fatigue strength and having a second loading mode, a second load ratio, and second life associated with the portion of the component. The fatigue strength model also may be configured to determine a third fatigue strength, the third fatigue strength being a single-load-mode fatigue strength and having a third loading mode, a third load ratio, and a third life associated with the portion of the component. The fatigue strength model further may be configured to determine, based at least in part on the first tensor invariant, the second tensor invariant, the third tensor invariant, the first fatigue strength, the second fatigue strength, and the third fatigue strength, an equivalent localized load measure associated with the portion of the component, such that the equivalent localized load measure is substantially independent of the orientation relative to the coordinate system.

According to some embodiments, a computer-readable storage medium having computer-executable instructions stored thereupon which, when executed by a computer, may cause the computer to receive a first localized load measure tensor signal indicative of a first localized load measure tensor associated with a first fatigue-relevant instant in time and a portion of the component, and receive a second localized load measure tensor signal indicative of a second localized load measure tensor associated with a second fatigue-relevant instant in time and the portion of the component. The first localized load measure tensor and the second localized load measure tensor may be determined at an orientation relative to a coordinate system. The computer may be further caused to determine, based at least in part on the first localized load measure tensor and the second localized load measure tensor, an equivalent mean localized load measure tensor and an equivalent alternating localized load measure tensor. The computer also may be caused to determine, based at least in part on the equivalent mean localized load measure tensor, the equivalent alternating localized load measure tensor, and material parameters associated with a material of the component, an equivalent mean octahedral shear localized load measure and an equivalent alternating octahedral shear localized load measure. The computer further may be caused to determine, based at least in part on the equivalent mean localized load measure tensor, the equivalent alternating localized load measure tensor, and the material parameters, an equivalent mean hydrostatic localized load measure and an equivalent alternating hydrostatic localized load measure. The computer also may be caused to determine, based at least in part on: (a) the equivalent mean octahedral localized load measure, (b) the equivalent alternating octahedral localized load measure, (c) the equivalent mean hydrostatic localized load measure, and (d) the equivalent alternating hydrostatic localized load measure, an equivalent localized load measure associated with the portion of the component, such that the equivalent localized load measure is substantially independent of the orientation relative to the coordinate system.

According to some embodiments, a computer-readable storage medium having computer-executable instructions stored thereupon which, when executed by a computer, cause the computer to receive a signal indicative of a first fatigue strength, the first fatigue strength being a single-load-mode fatigue strength and having a first loading mode, a first load ratio, and a first life associated with the portion of the component. The computer further may be caused to receive a signal indicative of a second fatigue strength, the second fatigue strength being a single-load-mode fatigue strength and having a second loading mode, a second load ratio, and second life associated with the portion of the component. The computer also may be caused to receive a signal indicative of a third fatigue strength, the third fatigue strength being a single-load-mode fatigue strength and having a third loading mode, a third load ratio, and a third life associated with the portion of the component. The computer further may be caused to receive a first localized load measure tensor signal indicative of a first localized load measure tensor associated with a first fatigue-relevant instant in time and a portion of the component, the first localized load measure tensor having a first tensor invariant. The computer further may be caused to receive a second localized load measure tensor signal indicative of a second localized load measure tensor associated with a second fatigue-relevant instant in time and the portion of the component, the second localized load measure tensor having a second tensor invariant. One of the first localized load measure tensor or the second localized load measure tensor may have a third tensor invariant. The third tensor invariant may be non-collinear relative to one of the first tensor invariant or the second tensor invariant of the one of the first localized load measure tensor or the second localized load measure tensor, and the first localized load measure tensor and the second localized load measure tensor may be determined at an orientation relative to a coordinate system. The computer also may be caused to determine a first fatigue strength, the first fatigue strength being a single-load-mode fatigue strength and having a first loading mode, a first load ratio, and a first life associated with the portion of the component. The computer further may be caused to determine a second fatigue strength, the second fatigue strength being a single-load-mode fatigue strength and having a second loading mode, a second load ratio, and second life associated with the portion of the component. The computer also may be caused to determine a third fatigue strength, the third fatigue strength being a single-load-mode fatigue strength and having a third loading mode, a third load ratio, and a third life associated with the portion of the component. The computer further may be caused to determine, based at least in part on the first tensor invariant, the second tensor invariant, the third tensor invariant, the first fatigue strength, the second fatigue strength, and the third fatigue strength, an equivalent localized load measure associated with the portion of the component, such that the equivalent localized load measure is substantially independent of the orientation relative to the coordinate system.

According to some embodiments, a system for enhancing prediction of fatigue strength associated with a component may include at least one processor configured to cause execution of a fatigue strength model configured to predict the fatigue strength of the component. The fatigue strength model may be configured to receive a first localized load measure tensor signal indicative of a first localized load measure tensor associated with a first fatigue-relevant instant in time and a portion of the component, and receive a second localized load measure tensor signal indicative of a second localized load measure tensor associated with a second fatigue-relevant instant in time and the portion of the component. The first localized load measure tensor and the second localized load measure tensor may be determined at an orientation relative to a coordinate system. The fatigue strength model further may be configured to determine, based at least in part on the first localized load measure tensor and the second localized load measure tensor, an equivalent mean localized load measure tensor and an equivalent alternating localized load measure tensor. The fatigue strength model also may be configured to determine, based at least in part on the equivalent mean localized load measure tensor, the equivalent alternating localized load measure tensor, and material parameters associated with a material of the component, an equivalent mean octahedral shear localized load measure and an equivalent alternating octahedral shear localized load measure. The fatigue strength model also may be configured to determine, based at least in part on the equivalent mean localized load measure tensor, the equivalent alternating localized load measure tensor, and the material parameters, an equivalent mean hydrostatic localized load measure and an equivalent alternating hydrostatic localized load measure. The fatigue strength model further may be configured to determine, based at least in part on: (a) the equivalent mean octahedral localized load measure, (b) the equivalent alternating octahedral localized load measure, (c) the equivalent mean hydrostatic localized load measure, and (d) the equivalent alternating hydrostatic localized load measure, an equivalent localized load measure associated with the portion of the component, such that the equivalent localized load measure is substantially independent of the orientation relative to the coordinate system.

According to some embodiments, a system for enhancing prediction of fatigue strength associated with a component may include at least one processor configured to cause execution of a fatigue strength model configured to predict the fatigue strength of the component. The fatigue strength model may be configured to receive a first localized load measure tensor signal indicative of a first localized load measure tensor associated with a first fatigue-relevant instant in time and a portion of the component, the first localized load measure tensor having a first tensor invariant. The fatigue strength model also may be configured to receive a second localized load measure tensor signal indicative of a second localized load measure tensor associated with a second fatigue-relevant instant in time and the portion of the component, the second localized load measure tensor having a second tensor invariant. One of the first localized load measure tensor or the second localized load measure tensor may have a third tensor invariant, the third tensor invariant being non-collinear relative to one of the first tensor invariant or the second tensor invariant of the one of the first localized load measure tensor or the second localized load measure tensor, and the first localized load measure tensor and the second localized load measure tensor being determined at an orientation relative to a coordinate system. The fatigue strength model further may be configured to determine a first fatigue strength, the first fatigue strength being a single-load-mode fatigue strength and having a first loading mode, a first load ratio, and a first life associated with the portion of the component. The fatigue strength model also may be configured to determine a second fatigue strength, the second fatigue strength being a single-load-mode fatigue strength and having a second loading mode, a second load ratio, and second life associated with the portion of the component. The fatigue strength model further may be configured to determine a third fatigue strength, the third fatigue strength being a single-load-mode fatigue strength and having a third loading mode, a third load ratio, and a third life associated with the portion of the component. The fatigue strength model also may be configured to determine, based at least in part on the first tensor invariant, the second tensor invariant, the third tensor invariant, the first fatigue strength, the second fatigue strength, and the third fatigue strength, an equivalent localized load measure associated with the portion of the component, such that the equivalent localized load measure is substantially independent of the orientation relative to the coordinate system.

According to some embodiments, a fatigue strength controller for enhancing production of a component, may be configured to receive a signal indicative of a geometry of the component, and receive a signal indicative of a material for forming the component. The material may have a material fatigue strength. The fatigue strength controller further may be configured to receive a signal indicative of a cyclic load to which the component is to be subjected, receive a signal indicative of a fully reversed tension fatigue strength, receive a signal indicative of a fully reversed torsion fatigue strength, receive a signal indicative of a repeated tension fatigue strength, and receive a signal indicative of a repeated torsion fatigue strength. The fatigue strength controller also may be configured to receive a signal indicative of material parameters associated with the material of the component. The fatigue strength controller further may be configured to receive a signal indicative of a first localized load measure tensor associated with a first fatigue-relevant instant in time and a portion of the component, and receive a signal indicative of a second localized load measure tensor associated with a second fatigue-relevant instant in time and the portion of the component, the first localized load measure tensor and the second localized load measure tensor being determined at an orientation relative to a coordinate system. The fatigue strength controller also may be configured to determine, based at least in part on the first localized load measure tensor and the second localized load measure tensor, an equivalent mean localized load measure tensor and an equivalent alternating localized load measure tensor. The fatigue strength controller also may be configured to determine, based at least in part on the equivalent mean localized load measure tensor and the equivalent alternating localized load measure tensor and material parameters, an equivalent mean octahedral shear localized load measure, an equivalent alternating octahedral shear localized load measure, an equivalent mean hydrostatic localized load measure, and an equivalent alternating hydrostatic localized load measure. The fatigue strength controller further may be configured to determine, via a fatigue strength analyzer and based at least in part on: (a) the equivalent mean octahedral localized load measure, (b) the equivalent alternating octahedral localized load measure, (c) the equivalent mean hydrostatic localized load measure, and (d) the equivalent alternating hydrostatic localized load measure, an equivalent localized load measure associated with the portion of the component, such that the equivalent localized load measure is substantially independent of the orientation relative to the coordinate system. When the equivalent localized load measure is less than or equal to the material fatigue strength, the fatigue strength controller further may be configured to generate a signal indicative of the equivalent localized load measure being less than or equal to the material fatigue strength.

According to some embodiments, a fatigue strength controller for enhancing production of a component may be configured to receive a signal indicative of a geometry of the component, and receive a signal indicative of a material for forming the component. The material may have a material fatigue strength. The fatigue strength controller further may be configured to receive a signal indicative of a first localized load measure tensor associated with a first fatigue-relevant instant in time and a portion of the component, the first localized load measure tensor having a first tensor invariant. The fatigue strength controller also may be configured to receive a signal indicative of a second localized load measure tensor associated with a second fatigue-relevant instant in time and the portion of the component. The second localized load measure tensor may have a second tensor invariant, one of the first localized load measure tensor or the second localized load measure tensor may have a third tensor invariant, the third tensor invariant may be non-collinear relative to one of the first tensor invariant or the second tensor invariant of the one of the first localized load measure tensor or the second localized load measure tensor, and the first localized load measure tensor and the second localized load measure tensor may be determined at an orientation relative to a coordinate system. The fatigue strength controller further may be configured to receive a signal indicative of a first fatigue strength, the first fatigue strength being a single-load-mode fatigue strength and having a first loading mode, a first load ratio, and a first life associated with the portion of the component. The fatigue strength controller also may be configured to receive a signal indicative of a second fatigue strength, the second fatigue strength being a single-load-mode fatigue strength and having a second loading mode, a second load ratio, and second life associated with the portion of the component. The fatigue strength controller further may be configured to receive a signal indicative of a third fatigue strength, the third fatigue strength being a single-load-mode fatigue strength and having a third loading mode, a third load ratio, and a third life associated with the portion of the component. The fatigue strength controller further may be configured to determine, based at least in part on the first tensor invariant, the second tensor invariant, the third tensor invariant, the first fatigue strength, the second fatigue strength, and the third fatigue strength, an equivalent localized load measure associated with the portion of the component, such that the equivalent localized load measure is substantially independent of the orientation relative to the coordinate system. When the equivalent localized load measure is less than or equal to the material fatigue strength, the fatigue strength controller also may be configured to generate a signal indicative of the equivalent localized load measure being less than or equal to the material fatigue strength.

Still other aspects and advantages of these exemplary embodiments and other embodiments, are discussed in detail herein. Moreover, it is to be understood that both the foregoing information and the following detailed description provide merely illustrative examples of various aspects and embodiments and are intended to provide an overview or framework for understanding the nature and character of the claimed aspects and embodiments. Accordingly, these and other objects, along with advantages and features of the present disclosure, will become apparent through reference to the following description and the accompanying drawings. Furthermore, it is to be understood that the features of the various embodiments described herein are not mutually exclusive and may exist in various combinations and permutations.

### BRIEF DESCRIPTION OF THE DRAWINGS

The accompanying drawings, which are included to provide a further understanding of the embodiments of the present disclosure, are incorporated in and constitute a part of this specification, illustrate embodiments of the present disclosure, and together with the detailed description, serve to explain principles of the embodiments discussed herein. No attempt is made to show structural details of this disclosure in more detail than may be necessary for a fundamental understanding of the embodiments discussed herein and the various ways in which they may be practiced. According to common practice, the various features of the drawings discussed below are not necessarily drawn to scale. Dimensions of various features and elements in the drawings may be expanded or reduced to more clearly illustrate embodiments of the disclosure.

FIG. 1 is a block diagram of an example system for enhancing prediction of fatigue strength associated with a component, including an example fatigue strength analyzer, an example fatigue analysis controller, an example fatigue strength model, and schematic diagrams representing a component subjected to compression and tension at two different instants in time, according to embodiments of the disclosure.

FIG. 2 is a block diagram of another example system for enhancing prediction of fatigue strength associated with a component, according to embodiments of the disclosure.

FIG. 3 is a block diagram of an example system for enhancing design and manufacturing of a component incorporating an example system for enhancing prediction of fatigue strength of the component, according to embodiments of the disclosure.

FIG. 4 is a schematic diagram showing an example component subjected to an example cyclic load including tension at a first instant in time and compression at a second instant in time, as well as corresponding stress tensors, according to embodiments of the disclosure.

FIG. 5 is a schematic diagram showing an example component subjected to an example cyclic load including tension as shown in FIG. 4 with an example Coordinate System A oriented to align the x-axis with a center axis of the component, and the same component and cyclic load in an example Coordinate System B in which the x-axis and γ-axis are oriented at 45 degrees about the System A z-axis, which is coincident with the System B z-axis, as well as corresponding stress tensors, according to embodiments of the disclosure.

FIG. 6 is a schematic diagram showing an example component subjected to an example cyclic load including pure torsion with an example Coordinate System A oriented to align the x-axis with a center axis of the component, and in the same component and cyclic load in an example Coordinate System B in which the x-axis and γ-axis are oriented at 45 degrees about the System A z-axis, which is coincident with the System B z-axis, as well as corresponding stress tensors, according to embodiments of the disclosure.

FIG. 7 graphically illustrates a comparison of accuracy and solve speed for example fatigue strengths models, including an example fatigue strength model, according to embodiments of the disclosure.

FIG. 8 is a graph showing the solve time for an example method for predicting the fatigue strength of an example component according to embodiments of the disclosure versus the mesh size, and the solve times versus mesh size for the same component for two comparison fatigue strength prediction methods.

FIG. 9A is a block diagram of an example method to enhance prediction of fatigue strength associated with a component, according to embodiments of the disclosure.

FIG. 9B is a continuation of the block diagram shown in FIG. 9A, according to embodiments of the disclosure.

FIG. 10 is a block diagram of an example method to enhance prediction of fatigue strength associated with a component, according to embodiments of the disclosure.

FIG. 11A is a block diagram of an example method to enhance design of a component, according to embodiments of the disclosure.

FIG. 11B is a continuation of the block diagram shown in FIG. 11A, according to embodiments of the disclosure.

FIG. 12 is a block diagram of an example method to enhance design of a component, according to embodiments of the disclosure.

FIG. 13A is a block diagram of an example method of enhancing manufacture of a component, according to embodiments of the disclosure.

FIG. 13B is a continuation of the block diagram shown in FIG. 13A, according to embodiments of the disclosure.

FIG. 14A is a block diagram of an example method of enhancing manufacture of a component, according to embodiments of the disclosure.

FIG. 14B is a continuation of the block diagram shown in FIG. 14A, according to embodiments of the disclosure.

FIG. 15A is a block diagram of an example method for enhancing simulation of effects of cyclic loading on a component having a component geometry and being formed from a component material having a material fatigue strength, according to embodiments of the disclosure.

FIG. 15B is a continuation of the block diagram shown in FIG. 15A, according to embodiments of the disclosure.

FIG. 16 is a block diagram of an example method for enhancing simulation of effects of cyclic loading on a component having a component geometry and being formed from a component material having a material fatigue strength, according to embodiments of the disclosure.

FIG. 17 is a schematic diagram of an example fatigue analysis controller, according to embodiments of the disclosure.

### DETAILED DESCRIPTION

The drawings include like numerals to indicate like parts throughout the several views, the following description is provided as an enabling teaching of exemplary embodiments, and those skilled in the relevant art will recognize that many changes may be made to the embodiments described. It also will be apparent that some of the desired benefits of the embodiments described may be obtained by selecting some of the features of the embodiments without utilizing other features. Accordingly, those skilled in the art will recognize that many modifications and adaptations to the embodiments described are possible and may even be desirable in certain circumstances. Thus, the following description is provided as illustrative of the principles of the embodiments and not in limitation thereof.

The phraseology and terminology used herein is for the purpose of description and should not be regarded as limiting. As used herein, the term “plurality” refers to two or more items or components. The terms “comprising,” “including,” “carrying,” “having,” “containing,” and “involving,” whether in the written description or the claims and the like, are open-ended terms, in particular, to mean “including but not limited to,” unless otherwise stated. Thus, the use of such terms is meant to encompass the items listed thereafter, and equivalents thereof, as well as additional items. The transitional phrases “consisting of” and “consisting essentially of,” are closed or semi-closed transitional phrases, respectively, with respect to any claims. Use of ordinal terms such as “first,” “second,” “third,” and the like in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish claim elements.

As used herein, the term “localized load measure” may refer to (a) stress (e.g., load per unit area) and/or any equivalent measure(s) of stress or combinations thereof; and/or (b) strain (e.g., change in length per characteristic length; or change in angle) and/or any equivalent measure(s) of strain or combinations thereof. Many examples disclosed herein relate or refer to “stress” (or “strain”). Unless otherwise indicated herein, at least some such examples could alternatively or additionally relate or refer to “strain” (or “stress”). For example, at least some embodiments disclosed herein may use stress-related characteristics for the purpose of fatigue-related determinations, may use strain-related characteristics for the purpose of fatigue-related determinations, or may use any combination of stress-related characteristics and strain-related characteristics for the purpose of fatigue-related determinations.

As used herein, the term “fatigue strength” may refer to a material property expressed in units of (a) stress; and/or (b) strain; and/or (c) load; and/or (d) distance and/or any equivalent measure(s) or combinations thereof, where the material property may be indicative of the maximum value of (a) stress; and/or (b) strain; and/or (c) load; and/or (d) distance and/or any equivalent measure(s) or combinations thereof for a specified number of cycles and/or for a specified period of time without the material experiencing a fatigue failure.

As discussed above, analytical fatigue models are used to predict the fatigue limit and the number of cycles to failure of a mechanical component for a given material when subjected to a cyclic loading or stress. For example, many mechanical components are subjected to cyclic stresses, and fatigue is the initiation and propagation of cracks in a material due to cyclic loading. The fatigue limit of a component formed from a given material is the magnitude of cyclic loading or stress below which the component would not be expected to fail due to the cyclic loading. Many fatigue strength estimation methods have been developed, and more recently, fatigue strength estimation methods have become increasingly complex. For example, critical-plane-based methods and integral-based methods have been shown to provide relatively more accurate estimations. Such methods, however, are complex, and relatively more simplified methods continue to be preferred in many instances. Due to the relative complexity, critical-plane-based methods and integral-based methods may be practical only when carried out with the aid of complex dedicated computer programs to perform the calculations associated with the often complex algorithms used to estimate fatigue strength. As a result, critical-plane-based methods and integral-based methods may be generally available to component designers only as costly commercially marketed fatigue solvers. Even when such commercial fatigue solvers are available to component designers, critical-plane-based methods and integral-based methods may be typically more computationally demanding due to, for example, the need to search and/or sum stresses through a high number of orientations about two axes in a three-dimensional domain, as well as at every point of interest. In many instances, such a large computational burden may often result in a user of these complex methods to forego potential accuracy in order to reduce computation time and expense. As a result, in order to achieve practical computation times, the potentially higher accuracy of critical-plane-based and integral-based methods may be largely lost by reducing the focus of the analysis, for example, by reducing the number of potential calculations performed by the analysis.

According to some embodiments, the systems, apparatuses, controllers, and methods presented herein may provide a fatigue strength analysis that is coordinate system invariant, and in many instances, is generally as accurate or more accurate, than more computationally complex critical-plane-based methods and/or integral-based methods. The systems, apparatuses, controllers, and methods presented herein, in some embodiments, may be used to enhance prediction of fatigue strength associated with a component and/or the number of cycles to failure of a component. In some embodiments, the systems, apparatuses, controllers, and methods presented herein may be used to assist with, evaluate, improve, or optimize the design of components that may be subjected to cyclic loading, for example, both linear and non-linear cyclic loading. For example, the systems, apparatuses, controllers, and methods presented herein may be incorporated into a machine-learning-trained analytical model that may be used to assist with, evaluate, improve, or optimize the design of components. In some embodiments, the systems, apparatuses, controllers, and methods presented herein may be used to assist with, evaluate, improve, or optimize the design of components, for example, without being used in association with a machine-learning-trained analytical model. In some embodiments, the systems, apparatuses, controllers, and methods presented herein may be used to enhance manufacturing of components. In some embodiments, the systems, apparatuses, controllers, and methods presented herein may be used to enhance the simulation of effects of cyclic loading on a component. In some embodiments, the systems, apparatuses, controllers, and methods presented herein may be combined with critical-plane-based fatigue analysis methods and/or with integral-based fatigue analysis methods.

As explained herein, in some embodiments, the systems, apparatuses, controllers, and methods for fatigue strength analysis presented herein may be computationally less complex than many other fatigue models, such as, for example, critical-plane-based fatigue analysis methods and/or integral-based fatigue analysis methods. In some embodiments, the systems, apparatuses, controllers, and methods for fatigue strength analysis presented herein may be executed in spreadsheet software, and, in some instances, without using macros. In some embodiments, the systems, apparatuses, controllers, and methods for fatigue strength analysis presented herein may be executed via, for example, common programmable controllers. This may result in a substantial improvement in computational efficiency compared to other fatigue analysis models that require substantial computing power to reach solutions of comparable accuracy, such as critical-plane-based methods and integral-based methods. In addition, unlike some less complex fatigue strength analysis methods, the systems, apparatuses, controllers, and methods for fatigue strength analysis presented herein, in some embodiments, may be coordinate system invariant, providing consistent results regardless of the coordinate system used and/or the orientation relative to the coordinate system chosen by the user of the systems, apparatuses, controllers, and methods. This may provide flexibility of choice when a coordinate system and/or orientation is selected for the fatigue strength analysis, and further, may provide enhanced confidence in the accuracy of the results due at least in part to this invariance.

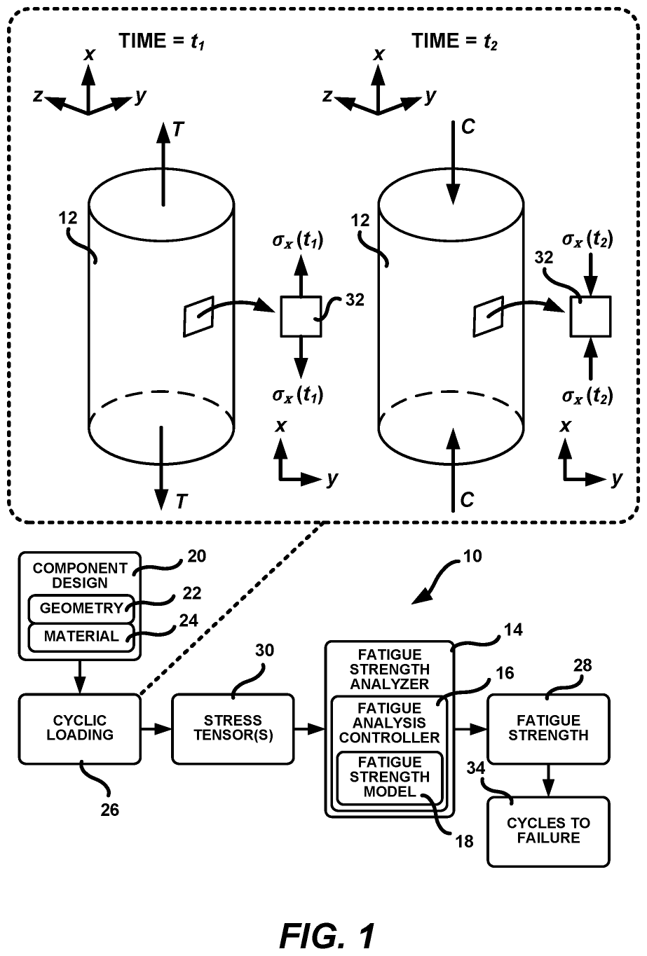

FIG. 1 is a block diagram of an example system 10 for enhancing prediction of fatigue strength associated with a component 12, including an example fatigue strength analyzer 14, an example fatigue analysis controller 16, an example fatigue strength model 18, and schematic diagrams representing an example component 12 subjected to compression and tension at two different instants in time t₁ and t₂, according to embodiments of the disclosure. In some embodiments, the two instants in time may be extended to evaluate a partial time history of fatigue loading related to a component or an entire time history of fatigue loading related to a component. For example, as shown in FIG. 1, a component 12 may be represented by a component design 20, which may include one or more characteristics of the component 12, such as, for example, a geometry 22 of the component 12 and a material 24 (or materials) forming the component 12. For example, the geometry 22 of the component 12 may be digitally represented, for example, in three-dimensions. For example, the geometry 22 may be generated via a computer running computer-aided design (CAD) software, for example, as will be understood by those skilled in the art. The material(s) 24 may be any known material or combination of materials having generally known material strength-related properties, such as, for example, yield strength, tensile strength, shear modulus, fatigue strength, and/or other known material properties.

In some embodiments, the system 10 may be configured to determine and/or receive signals indicative of a cyclic loading 26 to which the component 12 is to be subjected and predict fatigue strength 28 associated with the component 12. For example, as schematically shown in FIG. 1, the component 12 may be subjected to cyclic loading 26, for example, in the form of a cyclic tension load, a cyclic compression load, and/or an alternating tension load T and compression load C. For example, FIG. 1 schematically depicts an alternating tension T and compression C load at a first instant in time t₁ in tension, and at a second instant in time t₂ in compression. Other cyclic loading modes are contemplated, such as, for example, torsion, bending, pressure, and the like, and combinations thereof. FIG. 1 also schematically depicts the stress ox as a function of time for both the tension and compression loading modes, with the x-, y-, and z-axes for frame of reference. As shown in FIG. 1, the x-axis is aligned with the center of the component 12, although as noted herein, the x-, y-, and/or z-axes may have any orientation(s) relative to the component 12.

According to some embodiments, the fatigue strength analyzer 14 may be configured to receive one or more stress tensors 30 representative of the cyclic loading 26 and, based at least in part on the geometry 22 of the component 12, predict the fatigue strength 28 associated with the component 12, which may include, for example, determination of an equivalent localized load measure associated with a portion of the component 12 resulting from the cyclic loading 26. As noted herein, the term “localized load measure” may refer to (a) stress (e.g., load per unit area) and/or any equivalent measure(s) of stress or combinations thereof; and/or (b) strain (e.g., change in length per characteristic length; or change in angle) and/or any equivalent measure(s) of strain or combinations thereof. Many examples disclosed herein relate or refer to “stress” (or “strain”). Unless otherwise indicated herein, at least some such examples could alternatively or additionally relate or refer to “strain” (or “stress”). The “equivalent localized load measure” may include any equivalent fatigue-related stress, any equivalent fatigue-related strain, or combinations thereof. For example, the “equivalent localized load measure” may include an equivalent fully alternating stress, an equivalent repeated stress, a fully alternating torsion, an equivalent repeated torsion, and/or any equivalent fatigue stress (or strain) that may be comparable to fatigue strength.

In some embodiments, the stress tensors 30 may be manually determined and communicated, for example, in the form of one or more stress tensor signals, to the fatigue strength analyzer 14. In some embodiments, the stress tensors 30 may be determined via a computer running finite element analysis (FEA) software configured to determine the stress and/or stress tensors 30 at a given portion 32 of the component 12 due to the cyclic loading 26. In some embodiments, the fatigue strength analyzer 14 may be configured to determine the stress tensors 30 based at least in part on the cyclic loading 26 and/or the geometry 22 of the component 12.

As shown in FIG. 1, the fatigue strength analyzer 14, in some embodiments, may include a fatigue analysis controller 16 configured to predict the fatigue strength 28 of the component 12, for example, based at least in part on the one or more stress tensors 30. For example, in some embodiments, the fatigue analysis controller 16 may be configured to determine, for example, based at least in part on the one or more stress tensors 30, an equivalent fully alternating stress associated with the portion 32 of the component 12, such that the equivalent fully alternating stress is substantially independent of the orientation relative to the coordinate system with respect to which the component 12 is oriented. For example, in some embodiments, the fatigue analysis controller 16 may include one or more processors configured to execute a fatigue strength model 18, and the fatigue strength model 18 may be configured to predict the fatigue strength 28 of the component 12, for example, based at least in part on the one or more stress tensors 30, and/or, in some embodiments, the fatigue strength model 18 may be configured to determine, for example, based at least in part on the one or more stress tensors 30, an equivalent fully alternating stress associated with the portion 32 of the component 12, for example, as described herein. As noted herein, the fatigue strength model 18 may be configured to determine the equivalent fully alternating stress associated with the portion 32 of the component 12, such that the equivalent fully alternating stress is substantially independent of the orientation of the component 12 relative to the coordinate system.

As shown in FIG. 1, according to some embodiments, the fatigue strength analyzer 14 may be configured to determine the number of cycles to failure 34 of the component 12 due to the cyclic loading 26 and/or based on the geometry 22 of the component 12 and/or the one or more materials 24 from which the component 12 is formed. For example, in some embodiments, the fatigue strength analyzer 14 may be configured to use Basquin's equation or curve to determine the number of cycles to failure 34 of the component 12 due to the cyclic loading 26 and/or based on the geometry 22 of the component 12 and/or the one or more materials 24 from which the component 12 is formed. Other methods of determining the number of cycles to failure 34 are contemplated.

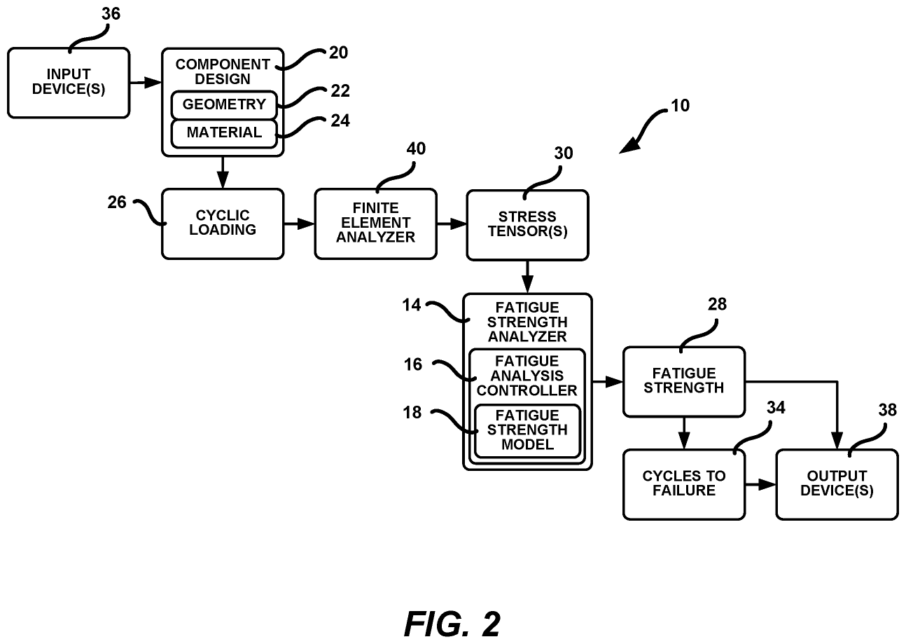

FIG. 2 is a block diagram of another example system 10 for enhancing prediction of fatigue strength 28 associated with a component 12, according to embodiments of the disclosure. The example shown in FIG. 2 is similar to the example shown in FIG. 1. According to some embodiments, the system 10 further may include one or more input devices 36 and/or one or more output devices 38. In some embodiments, the input device(s) 36 and the output device(s) 38 may be physically combined, for example, into an integrated input/output device. In some embodiments, the input device(s) 36 may be configured to facilitate communication of parameters to the fatigue strength analyzer 14. For example, the input device(s) 36 may facilitate communication of signals indicative of the geometry 22 of the component 12, the material(s) 24 forming the geometry 22 of the component 12, properties of the material(s) 24, loading characteristics of the cyclic loading 26, stress or stresses resulting from the cyclic loading 26 and/or the geometry 22 of the component 12, one or more stress tensors 30 representative of the stress or stresses, and/or one or more other parameters that may be used by the fatigue strength analyzer 14 for performance of the fatigue strength analysis. In some embodiments, the input device 36 may include a computer configured to provide one or more parameters to the fatigue strength analyzer 14, for example, from a location remote from the fatigue strength analyzer 14 and/or a user input device, such as a keyboard linked to a display associated with a computing device, a touchscreen of a smartphone, a tablet, a laptop, a handheld computing device, and/or other types of input devices. In some examples, a user associated with the fatigue strength analyzer 14 may provide one more of the parameters to the fatigue strength analyzer 14, and/or one or more of the parameters may be stored in computer memory and provided to the fatigue strength analyzer 14 upon initiation of an analysis.

In some embodiments, the output device(s) 38 may be configured to communicate results of a fatigue strength analysis to a user. For example, the output device(s) 38 may include one or more of a display, printer, speakers, and/or any other known types of output devices for communicating the results or other information associated with the fatigue strength analysis. For example, as shown in FIG. 2, the results of the analysis may include any information related to the fatigue strength 28 of the component 12 and/or any information related to the number of cycles to failure 34 of the component 12. In some embodiments, the output device(s) 38 may be adjacent or in the vicinity of the fatigue strength analyzer 14, and/or may be at a location physically remote from the fatigue strength analyzer 14, for example, in another building and/or at another geographic location.

As shown in FIG. 2, some embodiments of the system 10 may include a finite element analyzer 40 configured to determine one or more stress tensors 30. For example, the finite element analyzer 40 may include one or more computer processors configured to run or execute FEA software configured to determine the stress and/or stress tensors 30 at a given portion 32 of the component 12 due to the cyclic loading 26, for example, based at least in part on the geometry 22 of the component 12, as will be understood by those skilled in the art. In some embodiments, the finite element analyzer 40 may be physically or functionally separate from the fatigue strength analyzer 14. In some embodiments, the finite element analyzer 40 may be physically or functionally incorporated or integrated into the fatigue strength analyzer 14.

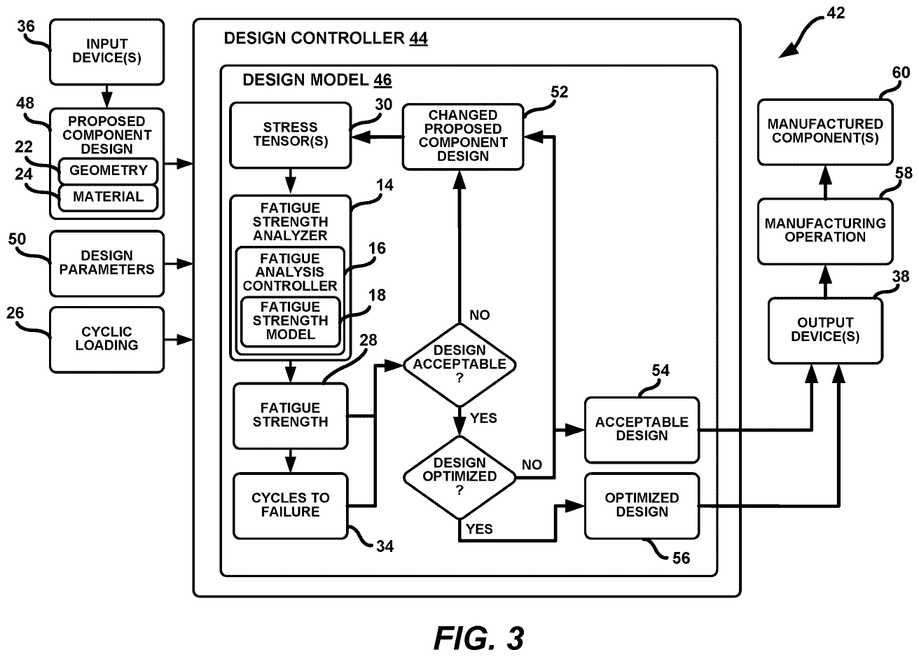

FIG. 3 is a block diagram of an example system 42 for enhancing design and/or manufacturing of a component 12 incorporating an example system 10 for enhancing prediction of fatigue strength of the component 12, according to embodiments of the disclosure. In some embodiments, as shown in FIG. 3, the system 42 for enhancing design may include a design controller 44, and the design controller 42 may include a design model 46, which may include an analytical model configured to determine one or more of whether a proposed component design 48 is acceptable and/or optimized. For example, the design controller 44 may be configured to receive one or more design parameters 50 that relate, for example, to desired characteristics of the component 12 once manufactured. For example, the design parameters 50 may relate to the physical dimensions of the proposed component design 48, the overall weight of the proposed component design 48, factors related to functional performance of the proposed component design 48, for example, the sealing effectiveness of a fluid seal, the economic efficiency of the proposed component design 48, and/or other characteristics of interest related to the proposed component design 48. In addition, as shown in FIG. 3, some embodiments of the design controller 44, via execution of the design model 46, may be configured to determine fatigue strength-related information about the proposed component design 48, such as, for example, the fatigue strength 28 of the proposed component design 48 and/or the number of cycles to failure 34 of the proposed component design 48. For example, as shown, the design model 46 may incorporate embodiments of the fatigue strength analyzer 14 therein, and the fatigue strength analyzer 14 may be configured to determine fatigue strength-related information about the proposed component design 48, such as, for example, the fatigue strength 28 of the proposed component design 48 and/or the number of cycles to failure 34 of the proposed component design 48.

As shown in FIG. 3, in some embodiments, the design model 46 may be configured to determine, based at least in part on the design parameters 50, whether the proposed component design 48 is acceptable and/or optimized. In some embodiments, if the design controller 44 determines that the proposed component design 48 is not acceptable, the design controller 44 may be configured to initiate a change in the proposed component design 48 to generate a changed proposed component design 52, such as, for example, a change in the geometry 22 and/or a change in material(s) 24 of the proposed component design 48. Thereafter, the design controller 44 may be configured to evaluate the changed proposed component design 52 and determine whether the changed proposed component design 52 is acceptable and/or optimized. Similarly, if the design controller 44 determines that the proposed component design 48 is acceptable but is not optimized based at least in part on the design parameters 50, the design controller 44 may be configured to initiate a change in the proposed component design 48 to generate a changed proposed component design 52, such as, for example, a change in the geometry 22 and/or a change in material(s) 24 of the proposed component design 48. Thereafter, the design controller 44 may be configured to evaluate the changed proposed component design 52 and determine whether the changed proposed component design 52 is acceptable and/or optimized. In some embodiments, these processes may be repeated until the design controller 44 determines that the proposed component design 48 or a changed proposed component design 52 is acceptable and/or optimized, depending at least in part on the design parameters 50. In some embodiments, the design controller 44 and/or the design model 46 may include, for example, a machine-learning-trained analytical model. For example, the machine-learning-trained analytical model may be trained with training datasets related to optimizing the component design and/or may be configured to iteratively generate and evaluate a plurality of proposed component designs and change its underlying algorithm based at least in part on results of the evaluations, for example, until the proposed component design 48 is acceptable and/or optimized based at least in part on the design parameters 50. In some embodiments, the proposed component design 48 and/or any changed proposed component designs 52 may be manually generated, for example, via hand and/or use of a computer running CAD software and/or a computer running FEA software.

In some embodiments, as shown in FIG. 3, if the design controller 44 determines that the proposed component design 48 or a changed proposed component design 52 is acceptable and/or optimized, the design controller may be configured to output an acceptable design 54 and/or an optimized design 56, for example, via one or more output device(s) at least similar to the output device(s) 38 described herein with respect to FIG. 2. Following determination and/or output of the acceptable design 54 and/or the optimized design 56, a manufacturing operation 58 may be used to manufacture a component 12 based at least in part on the acceptable design 54 and/or the optimized design 56, thereby to result in one or more manufactured component(s) 60. The manufacturing operation 58 may include any known manufacturing process or processes for manufacturing the manufactured component 60.

The manufactured component 60 may be any type of mechanical component. For example, the manufactured component may include any mechanical component associated with an oilfield operation. For example, the manufactured component 60 may include any oilfield operational component, such as, for example, a fluid manifold, a fluid conduit, a connector, a fluid end block, a power end frame, a crankshaft, a connecting rod, a plunger, a valve body, a valve seat, or a stud. Other oilfield operational components and non-oilfield operational components are contemplated.

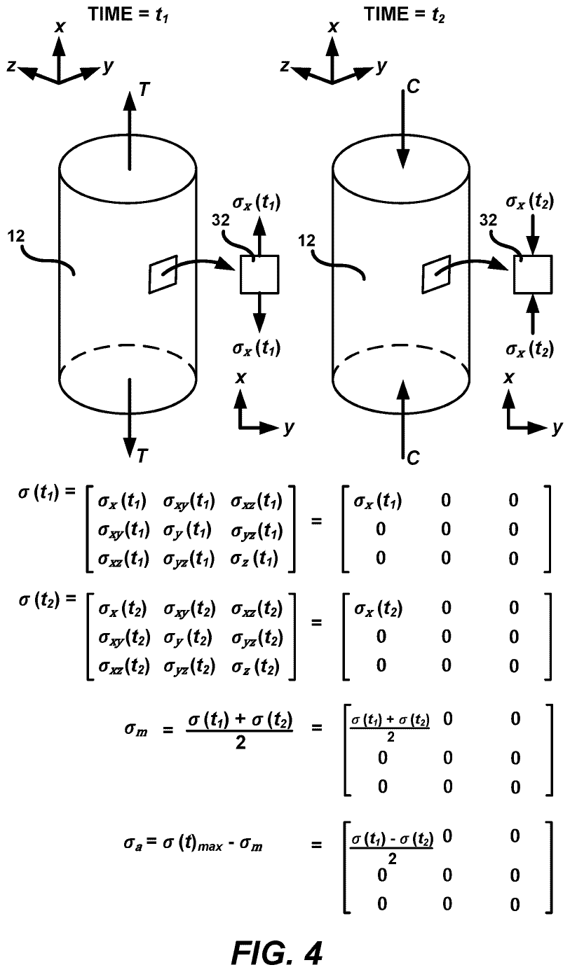

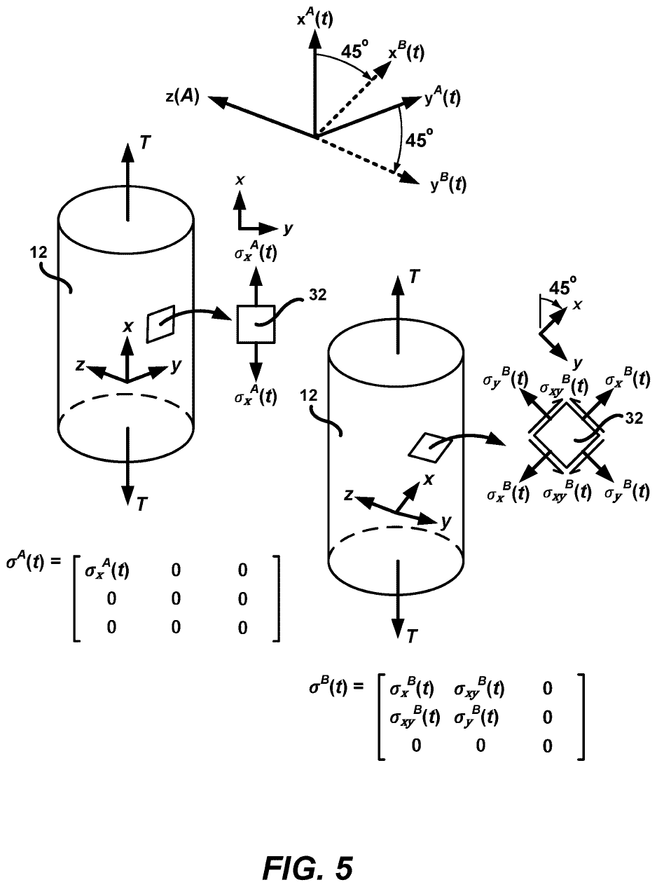

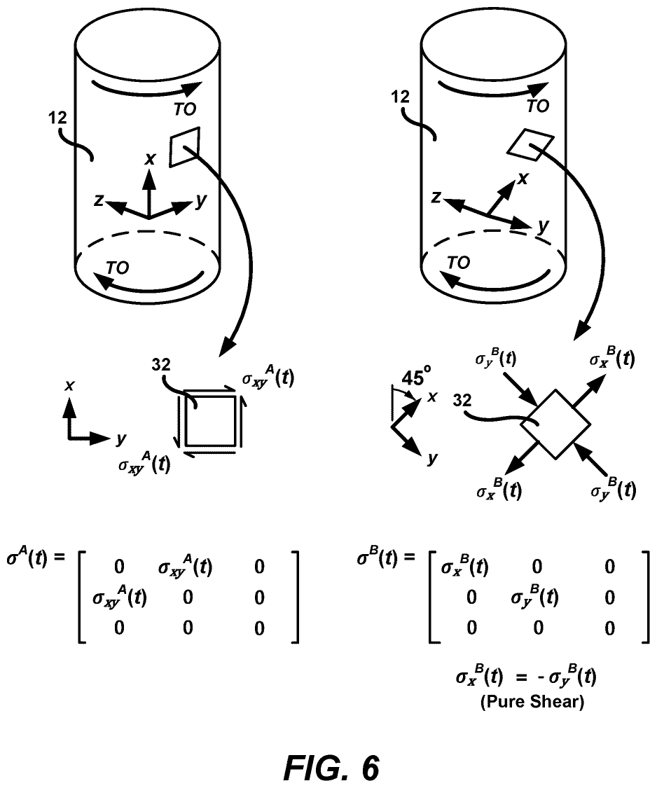

FIG. 4 is a schematic diagram showing an example component 12 subjected to an example cyclic load including tension at a first instant in time t₁ and compression at a second instant in time t₂, as well as corresponding stress tensors σ(t₁) and (t₂), according to embodiments of the disclosure. As described herein, the component 12 may be subjected to cyclic loading 26, for example, in the form of a cyclic tension load, a cyclic compression load, and/or an alternating tension load T and compression load C. For example, FIG. 4 schematically depicts an alternating tension T and compression C load at a first instant in time t₁ in tension, and at a second instant in time t₂ in compression. Other cyclic loading modes are contemplated, such as, for example, torsion, bending, pressure, and the like, and combinations thereof. FIG. 4 also schematically depicts the stress ox as a function of time for both the tension and compression loading modes, with the x-, y- and z-axes for frame of reference. As shown in FIG. 4, the x-axis is aligned with the center of the component 12, although as noted herein, the x-, y-, and/or z-axes axis may have any orientation(s) relative to the component 12, for example, as described herein with respect to FIGS. 5 and 6. FIG. 4 also illustrates the stress tensors corresponding to the mean stress σₘ and alternating stress O a for the stress state schematically depicted in FIG. 4.

FIG. 5 is a schematic diagram showing an example component 12 at an instant in time tr subjected to an example cyclic load including tension in an example Coordinate System A and an example Coordinate System B, according to embodiments of the disclosure. As shown, the example System A is oriented to align the x-axis with a center axis of the component 12, for example, at least similar to FIG. 4. In contrast, in System B, the x-axis and γ-axis are oriented at 45 degrees about the System A z-axis, which is coincident with the System B z-axis. FIG. 5 also depicts the corresponding stress tensors σ⁴(t) and σ^{B}(t), where the time t is the same. As shown in FIG. 5, changing the orientation of the coordinate system alone relative to the component and/or the stress may result in changing the matrix representation of the stress tensors. As noted herein, selection of the orientation of the coordinate system may be arbitrary, and thus, it may be important for a fatigue strength model to yield consistent results, regardless of the orientation of the coordinate system, for example, such that the fatigue strength model is invariant with respect to the orientation of the coordinate system. As described herein, the fatigue strength model 18 according to at least some embodiments described herein is invariant with respect to the orientation of the coordinate system, yielding consistent results, regardless of the orientation of the orientation of the coordinate system.

FIG. 6 is a schematic diagram showing an example component 12 subjected to an example cyclic load including pure torsion, according to embodiments of the disclosure. FIG. 6 shows an example Coordinate System A oriented to align the x-axis with a center axis of the component 12, and in the same component 12 and cyclic load in an example Coordinate System B in which the x-axis and γ-axis are oriented at 45 degrees about the System A z-axis, which is coincident with the System B z-axis. FIG. 6 also shows the corresponding stress tensors σ^{A}(t) and σ^{B}(t), where the time t is the same. As shown in FIG. 6, σₓ^{B}(t)=−σ_{y}^{B}(t), which corresponds to a pure shear condition. (Pure shear causes the numerical value of ox to be equal and opposite to the numerical value of σ_{y}. A positive value means the stress points outwardly, normal to the stress element. A negative value means the stress points inwardly, normal to the stress element. As schematically shown in FIG. 6, σₓ points outward and its numerical value is positive (in tension), and σ_{y} points inward, and thus its numerical value is negative (in compression). As shown, the arrows indicate the direction of the stresses.)

Similar to FIG. 5, changing the orientation of the coordinate system alone relative to the component 12 and/or the stress may result in changing the matrix representation of the stress tensors. As noted herein, it may be important for a fatigue strength model to yield consistent results, regardless of the orientation of the coordinate system, for example, such that the fatigue strength model is invariant with respect to the orientation of the coordinate system. As described herein, the fatigue strength model 18 according to at least some embodiments described herein is invariant with respect to the orientation of the coordinate system, yielding consistent results, regardless of the orientation of the orientation of the coordinate system.

In some embodiments, the fatigue strength model 18 may be used to enhance prediction of fatigue strength associated with the component 12. For example, the fatigue strength model 18 may be configured to determine or receive a signal indicative of a first localized load measure tensor associated with a first fatigue-relevant instant in time and a portion of the component 12. The first localized load measure tensor may have a first tensor invariant. The fatigue strength model 18 further may be configured to determine or receive a signal indicative of a second localized load measure tensor associated with a second fatigue-relevant instant in time and the portion of the component 12. The second localized load measure tensor may have a second tensor invariant, and one of the first localized load measure tensor or the second localized load measure tensor may have a third tensor invariant. The third tensor invariant may be non-collinear relative to one of the first tensor invariant or the second tensor invariant of the one of the first localized load measure tensor or the second localized load measure tensor. The first localized load measure tensor and the second localized load measure tensor may be determined at an orientation relative to a coordinate system. The fatigue strength model 18 may further be configured to determine or receive a signal indicative of a first fatigue strength, the first fatigue strength being a single-load-mode fatigue strength and having a first loading mode, a first load ratio, and a first life associated with the portion of the component 12. The fatigue strength model 18 also may be configured to determine or receive a signal indicative of a second fatigue strength, the second fatigue strength being a single-load-mode fatigue strength and having a second loading mode, a second load ratio, and a second life associated with the portion of the component. The fatigue strength model 18 further may be configured to determine or receive a signal indicative of a third fatigue strength, the third fatigue strength being a single-load-mode fatigue strength and having a third loading mode, a third load ratio, and a third life associated with the portion of the component 12. In some embodiments, the third fatigue strength may be the same as one of the first loading mode or the second loading mode (e.g., the same type of loading mode), and the third load ratio may be different than one of the first load ratio or the second load ratio of the one of the first fatigue strength or the second fatigue strength. The first life, the second life, and/or the third life may include or be indicative of a number of load cycles or a time period. The fatigue strength model 18 also may be configured to determine, based at least in part on the first tensor invariant, the second tensor invariant, the third tensor invariant, the first fatigue strength, the second fatigue strength, and the third fatigue strength, an equivalent localized load measure (e.g., an equivalent fully alternating stress) associated with the portion of the component 12, for example, such that the equivalent localized load measure is substantially independent of the orientation relative to the coordinate system. In some embodiments, a single-load-mode fatigue strength may include, for example, pure tension, pure torsion, pure bending, pure pressure, etc., as will be understood by those skilled in the art, for example, as compared to non-single-load-mode fatigue strengths, such as torsion with tension, bending with torsion, pressure with tension, etc., as will be understood by those skilled in the art.

As noted herein, in some embodiments, one or more of the first localized load measure tensor, the second localized load measure tensor, or the third localized load measure tensor may be communicated to the fatigue strength model 18. In some embodiments, one or more of the first tensor invariant, the second tensor invariant, or the third tensor invariant may be communicated to the fatigue strength model 18. For example, one or more of the localized load measure tensors 30 and/or one or more of the tensor invariants may be determined manually and/or via a finite element analysis and communicated as an input to the fatigue strength analyzer 14 and/or the fatigue strength model 18.

In some embodiments, the first tensor invariant, the second tensor invariant, and the third tensor invariant are independent of one another. Some embodiments may use up to six (or more) tensor invariants.

According to some embodiments, the first loading mode may include a first uniaxial load, the second loading mode may include a first torsional load, and the third loading mode may include either a second uniaxial load or second a torsional load. In at least some such embodiments, (a) the third loading mode may include a second uniaxial load associated with the portion of the component, and the second uniaxial load may have a second uniaxial load ratio different than the first load ratio; and/or (b) the third loading mode may include a second torsional load associated with the portion of the component, and the second torsional load may have a second torsional load ratio different than the first torsional load ratio.

In some embodiments, the coordinate system may include, for example, a three-dimensional coordinate system, a stress-based (and/or strain-based) coordinate system, a cartesian coordinate system, a cylindrical coordinate, a spherical coordinate system, and/or any other known coordinate system types suitable for fatigue localized load measure analysis. As noted herein, at least some embodiments of the fatigue strength model 18 are substantially invariant (e.g., completely invariant) relative to coordinate system orientation.

In some embodiments, the first tensor invariant or the second tensor invariant may be indicative or representative of (a) von Mises stress; (b) the second invariant of the deviatoric stress tensor; and/or (c) octahedral shear stress. In some embodiments, the first tensor invariant and/or the second tensor invariant may be indicative or representative of (a) the first invariant of the stress tensor and/or (b) hydrostatic stress.

In some embodiments, the fatigue strength model 18 may be configured to (a) determine, based at least in part on the first localized load measure tensor and the second localized load measure tensor, an equivalent mean localized load measure tensor; (b) determine, based at least in part on the first localized load measure tensor and the second localized load measure tensor, an equivalent alternating localized load measure tensor; (c) determine, based at least in part on the equivalent mean localized load measure tensor and the equivalent alternating localized load measure tensor, an equivalent mean octahedral shear localized load measure; (d) determine, based at least in part on the equivalent mean localized load measure tensor and the equivalent alternating localized load measure tensor, an equivalent alternating octahedral shear localized load measure; (e) determine, based at least in part on the equivalent mean localized load measure tensor and the equivalent alternating localized load measure tensor, an equivalent mean hydrostatic localized load measure; and/or (f) determine, based at least in part on the equivalent mean localized load measure tensor and the equivalent alternating localized load measure tensor, an equivalent alternating hydrostatic localized load measure. For example, some embodiments of the fatigue strength model 18 may be configured to determine the equivalent fully alternating localized load measure associated with the portion of the component 12 based at least in part on (a) the equivalent mean octahedral shear localized load measure, (b) the equivalent alternating octahedral shear localized load measure, (c) the equivalent mean hydrostatic localized load measure, or (d) the equivalent alternating hydrostatic localized load measure. For example, the fatigue strength model 18 may be configured to determine one or more of: (1) an equivalent mean localized load measure based at least in part on the equivalent mean octahedral shear localized load measure and the equivalent mean hydrostatic localized load measure; (2) an equivalent alternating load measure based at least in part on the equivalent alternating octahedral shear localized load measure and the equivalent alternating hydrostatic localized load measure; or (3) the equivalent localized load measure associated with the portion of the component based at least in part on one or more of the equivalent mean localized load measure and the equivalent alternating load measure.

The fatigue strength model 18, according to some embodiments, may be configured to modify the equivalent fully alternating localized load measure via analysis using (a) a critical-plane-theory-based fatigue analysis method and/or (b) an integral-based fatigue analysis method. In at least some such embodiments, the fatigue strength model 18 may partially or fully incorporate therein a known critical-plane-theory-based fatigue analysis method and/or a known integral-based fatigue analysis method, thereby providing a hybrid version of the fatigue strength model 18. The fatigue strength model 18, according to some embodiments, may be configured to modify the equivalent fully alternating localized load measure via analysis using one or more of: (a) a rectangular hull-related fatigue analysis method; (b) a minimum circumscribed sphere-related fatigue analysis method; or (c) a minimum circumscribed ellipsoid-related fatigue analysis method. In at least some such embodiments, the fatigue strength model 18 may partially or fully incorporate therein a known rectangular hull-related fatigue analysis method, a known minimum circumscribed sphere-related fatigue analysis method, and/or a known minimum circumscribed ellipsoid-related fatigue analysis method, thereby providing a hybrid version of the fatigue strength model 18.

In some embodiments, the fatigue strength model 18 may be configured to account for in-phase loading conditions and/or out-of-phase loading conditions. In-phase loading conditions may apply, for example, when a component is subjected to uniaxial loading and torsional loading that vary (e.g., oscillating between tension and compression and/or oscillating between positive and negative torque) in a synchronous manner with one another. Out-of-phase loading may apply, for example, when a component is subjected to uniaxial loading, such as varying tension and compression on alternating odd seconds, and the component is also subjected to torsional loading, such as varying positive and negative torque on alternating even seconds. In some embodiments, the fatigue strength model 18 may be modified to account for out-of-phase loading conditions by incorporating at least some aspects of one or more of: (a) a rectangular hull-related fatigue analysis method; (b) a minimum circumscribed sphere-related fatigue analysis method; or (c) a minimum circumscribed ellipsoid-related fatigue analysis method.

In some embodiments, the analysis by the fatigue strength model 18 may be modified, for example, by use of a parameter whose definition allows it to vary in sign, to apply to part or all of the equivalent uniaxial mean stress value. At least some such embodiments may be valuable for methods whose equivalent uniaxial mean stress value would otherwise always be positive, or not low enough, due to the mean stress formulation. In some embodiments, the analysis by the fatigue strength model 18 may be modified, for example, by use of a parameter whose definition does not allow it to vary in sign, but whose definition allows it to vary, for example, from zero to one.

The fatigue strength model 18, in some embodiments, may be configured to determine the fully reversed alternating fatigue limit, the repeated fatigue limit, either in tension, torsion, or to some other fatigue strength, for example, for various types of loading modes and/or load ratios of interest.

According to some embodiments, the fatigue strength model 18 may be configured to determine or receive one or more signals indicative of a fully reversed tension fatigue strength associated with a component 12, a fully reversed torsion fatigue strength associated with a component 12, a repeated tension fatigue strength associated with a component 12, and a repeated torsion fatigue strength associated with a component 12. The fatigue strength model 18 further may be configured to determine or receive one or more signals indicative of material parameters associated with the component 12, based in at least in part on the fully reversed tension fatigue strength, the fully reversed torsion fatigue strength, the repeated tension fatigue strength, and the repeated torsion fatigue strength. The fatigue strength model 18 also may be configured to determine or receive one or more signals indicative of material parameters associated with the component 12. The fatigue strength model 18 further may be configured to determine or receive one or more signals indicative of a first localized load measure tensor associated with a first fatigue-relevant instant in time and a portion of the component 12. The fatigue strength model 18 also may be configured to determine or receive one or more signals indicative of a second localized load measure tensor associated with a second fatigue-relevant instant in time and the portion of the component. The first localized load measure tensor and the second localized load measure tensor may be determined at an orientation relative to a coordinate system. The fatigue strength model 18 also may be configured to determine, based at least in part on the first localized load measure tensor and the second localized load measure tensor, an equivalent mean localized load measure tensor and an equivalent alternating localized load measure tensor. Based at least in part on the equivalent mean localized load measure tensor, the equivalent alternating localized load measure tensor, and the material parameters, the fatigue strength model 18 also may be configured to determine an equivalent mean octahedral shear localized load measure and an equivalent alternating octahedral shear localized load measure. The fatigue strength model 18 further may be configured to determine, based at least in part on the equivalent mean localized load measure tensor, the equivalent alternating localized load measure tensor, and the material parameters, an equivalent mean hydrostatic localized load measure and an equivalent alternating hydrostatic localized load measure. In some embodiments, the fatigue strength model 18 also may be configured to determine an equivalent localized load measure (e.g., an equivalent fully alternating stress) associated with the portion of the component 12, for example, based at least in part on: (a) the equivalent mean octahedral localized load measure, (b) the equivalent alternating octahedral localized load measure, (c) the equivalent mean hydrostatic localized load measure, (d) the equivalent alternating hydrostatic localized load measure, and (e) the material parameters. As noted herein, the equivalent localized load measure may be substantially independent of the orientation relative to the coordinate system, for example, completely independent of the orientation relative to the coordinate system.

As noted herein, in some embodiments, one or more of the first localized load measure tensor, the second localized load measure tensor, the equivalent mean localized load measure tensor, the equivalent alternating localized load measure tensor, the equivalent mean octahedral shear localized load measure, the equivalent alternating octahedral shear localized load measure, the equivalent mean hydrostatic localized load measure, and/or the equivalent alternating hydrostatic localized load measure may be communicated to the fatigue strength model 18. For example, one or more of the above may be determined manually and/or via a finite element analysis and communicated as an input to the fatigue strength analyzer 14 and/or the fatigue strength model 18.

In some embodiments, the component 12 may include or be formed from one or more materials, and the fatigue strength model 18 may be configured to compare the equivalent fully alternating localized load measure to one or more multi-axially loaded fatigue limits associated with the one or more materials. In some embodiments, comparing the equivalent fully alternating localized load measure to the one or more multi-axially loaded fatigue limits may include determining a ratio of the one or more multi-axially loaded fatigue limits to the equivalent fully alternating localized load measure. Comparing the equivalent fully alternating localized load measure to the one or more multi-axially loaded fatigue limits, according to some embodiments, may include comparing the equivalent fully alternating localized load measure to: (a) a fully reversed tension fatigue limit associated with the material, (b) a repeated tension fatigue limit associated with the material, (c) a fully reversed torsion fatigue limit associated with the material, and/or (d) a repeated torsion fatigue limit associated with the material.

In some embodiments, the first localized load measure tensor and the second localized load measure tensor may be indicative or representative of a cyclic load to which the component 12 is subjected, and the fatigue strength model 18 may be configured to predict, based at least in part on the equivalent fully alternating localized load measure, the number of cycles to failure of the component due to the cyclic load. This may be performed via, for example, the use of Basquin's equation and/or other similar methods.

The fatigue strength model 18, in some embodiments, may be configured to determine a stress triaxiality parameter indicative of effects of negative mean stress on the equivalent localized load measure. The fatigue strength model 18 may use the stress triaxiality parameter to modify the equivalent mean octahedral shear localized load measure and/or the equivalent alternating octahedral shear localized load measure. In some embodiments, the stress triaxiality parameter may be communicated to the fatigue strength model 18 as an input.

In some embodiments, the fatigue strength model 18 may be configured to determine a mean stress correction parameter indicative of effects of mean stress on the equivalent localized load measure (e.g., an equivalent fully alternating stress). The fatigue strength model 18 may use the mean stress correction parameter to modify the equivalent localized load measure (e.g., an equivalent fully alternating stress). In some embodiments, the mean stress correction parameter may be based at least in part on a reversed tensile stress and/or a repeated tensile stress associated with the portion of the component 12. For example, the mean stress correction parameter may include a Smith-Watson-Topper (SWT) mean stress correction factor, a Bergmann mean stress correction factor, a Walker mean stress correction factor, a multi-linear mean stress correction factor, and/or a tabular mean stress correction factor. In some embodiments, the mean stress correction parameter may be communicated to the fatigue strength model 18 as an input.

Determining the first localized load measure tensor associated with the first fatigue-relevant instant in time and the second localized load measure tensor associated with the second fatigue-relevant instant in time may include: (a) determining the first localized load measure tensor at a first instant in time corresponding to a minimum load to which the portion of the component is subjected, and (b) determining the second localized load measure tensor at a second instant in time corresponding to a maximum load to which the portion of the component is subjected.

The fatigue strength model 18 in some embodiments may be configured to determine one or more additional localized load measure tensors associated with respective one or more additional fatigue-relevant instants in time associated with the portion of the component 12. For example, the fatigue strength model 18 may be configured to determine the equivalent mean localized load measure tensor and the equivalent alternating localized load measure tensor based at least in part on the first localized load measure tensor, the second localized load measure tensor, and the one or more additional localized load measure tensors. In some embodiments, the first localized load measure tensor, the second localized load measure tensor, and the one or more additional localized load measure tensors may be indicative of a non-proportional load on the component.

As noted herein, some embodiments of the fatigue strength model 18 may be computationally very efficient, for example, relative to critical-plane-based fatigue analysis methods and integral-based fatigue analysis methods. For example, at least some embodiments of the fatigue strength model 18 may be incorporated into and executed by relatively simple or non-complex software, such as spreadsheet software, rather than relatively more complex software designed specifically to execute critical-plane-based fatigue analysis methods and integral-based fatigue analysis methods. As noted herein, such embodiments may render them more computationally efficient, saving critical and/or valuable computer resources and rendering the fatigue strength model 18 more user friendly and cost efficient.

### Examples

According to some embodiments, the fatigue strength model 18 of the present disclosure may offer simplicity and speed of solve, while delivering accuracy comparable or in the same range as at least some relatively more complex critical-plane-based fatigue analysis methods and/or some relatively more complex integral-based fatigue analysis methods. The fatigue limit estimation accuracy of the fatigue strength model 18 according to at least some embodiments disclosed herein was measured against two data sets. The first data set is the complete FatLim data set of 287 unique test cases, including multiaxial stress states from combinations of tension, internal pressure, bending, and torsion; for various materials, such as hard and mild steels, aluminums, cast irons; compressive through high tensile mean stresses; and proportional and non-proportional loading. The second data set is the representative 57-case AMSD25 benchmark set containing the most challenging test cases from the 287 unique test cases, but without over-weighting any one type of challenge. The limit estimations accuracy of the fatigue strength model 18 disclosed herein was compared to two comparable fatigue analysis methods often used by industry (the Dang Van and Sines methods) and several critical-plane-based methods. As shown by the comparison below, the fatigue strength model 18 according to at least some embodiments of the disclosure delivers a combination of accuracy and ease of use.

According to some embodiments, the fatigue strength model 18 may employ both the first invariant of the stress tensor (e.g., the hydrostatic stress) and the second invariant of the stress deviator tensor for both the equivalent one-dimensional alternating stress component and the equivalent one-dimensional mean stress component, for example, as follows:

$${D}_{CBP} = \sqrt{{σ}_{aB} ( {σ}_{aB} + {k}_{Berg} \cdot {σ}_{mB} )}$$

$${σ}_{aB} = {a}_{aB} \cdot \sqrt{{J}_{2 , a}} + {b}_{aB} \cdot {σ}_{aH}$$

$${σ}_{mB} = {a}_{mB} \cdot \sqrt{{J}_{2 , m}} + {b}_{mB} \cdot {σ}_{m H}$$

$${σ}_{aH} = \frac{{σ}_{x , a} + {σ}_{y , a} + {σ}_{z , a}}{3}$$

$${σ}_{m H} = \frac{{σ}_{x , m} + {σ}_{y , m} + {σ}_{z , m}}{3}$$

$${a}_{aB} = κ$$

$${a}_{mB} = \frac{{( \frac{2 {t}_{- 1}}{{t}_{0}} )}^{2} - 1}{{k}_{Berg} \cdot κ}$$

$${b}_{aB} = 3 - \sqrt{3} κ$$

$${b}_{mB} = 3 - \sqrt{3} {a}_{mB}$$

$${k}_{Berg} = {( \frac{2 {f}_{- 1}}{{f}_{0}} )}^{2} - 1$$

As indicated above, according to some embodiments of the fatigue strength model 18, a biaxiality coefficient β is not used, although the use of the biaxiality coefficient β may be used. In some fatigue strength analysis methods, the biaxiality coefficient β may be necessary to address the inherent positiveness of the von Mises-like stress, which defines the equivalent one-dimensional mean stress component in some methods. Without the biaxiality coefficient β, some such methods may be incapable of predicting the experimentally observed benefit of compressive (negative) mean stresses. Because at least some embodiments of the fatigue strength model 18 disclosed herein directly use the mean hydrostatic stress σ_{mH}, for example, as compared to only the sign of the hydrostatic stress, as applied in some methods, the biaxiality coefficient β may be rendered obsolete. According to some embodiments, the fatigue strength model 18 may use the mean hydrostatic stress σ_{mH}, which may facilitate prediction of possible benefits of compressive mean stresses directly.

According to some embodiments, the lack of the need to use the biaxiality coefficient β may result in several relative benefits. For example, in shear-dominate load situations, the dominance of shear load may result in the biaxiality coefficient β (β=sign (σ_{mH})) being particularly sensitive, thereby greatly effecting the results of the analysis for methods that use the biaxiality coefficient β. According to some embodiments, the fatigue strength model 18 may avoid erratic prediction behavior of methods that use the biaxiality coefficient β, at least for some load situations, such as shear-dominant loads.

In some embodiments, the fatigue strength model 18 may use a mean stress correction factor, such as the Bergmann formulation, which may provide potentially improved relative accuracy, for example, as compared to the use of the Walker mean stress correction factor formulation. In some embodiments, the Walker formulation may be used. Both the Walker formulation and the Bergman formulation are generalizations of the Smith-Watson-Topper (SWT) mean stress correction factor formulation.

In some embodiments, the fatigue strength model 18 may use four coefficients derived from the four fatigue limits, which may provide reliable reproduction of the four fatigue limits. For example, for repeated torsion, the α_{mB} coefficient may be used, which treats mean shear stresses present in repeated torsion situations.

In some embodiments, the fatigue strength model 18 may use only strict invariants in its analysis, and thus, the fatigue strength model itself may be invariant. According to some embodiments, the alternating stress tensor σₐ and the mean stress tensor σₘ may be expressed as follows:

$${σ}_{a} = \frac{{f}_{- 1}}{2} [ \begin{matrix}1 & 1 & 0 \\ 1 & 1 & 0 \\ 0 & 0 & 0\end{matrix} ] , {σ}_{m} = [ \begin{matrix}0 & 0 & 0 \\ 0 & 0 & 0 \\ 0 & 0 & 0\end{matrix} ] .$$

Based on this example formulation, for at least some embodiments, the equivalent alternating stress component σ_{aB} may be expressed as follows:

$${σ}_{aB} = {a}_{aB} \sqrt{\frac{1}{6} ( {( 0 )}^{2} + {( \frac{{f}_{- 1}}{2} )}^{2} + {( - \frac{{f}_{- 1}}{2} )}^{2} + 6 {( \frac{{f}_{- 1}}{2} )}^{2} )} + {b}_{aB} \frac{\frac{{f}_{- 1}}{2} + \frac{{f}_{- 1}}{2} + 0}{3}$$

$${σ}_{aB} = {a}_{aB} \sqrt{\frac{1}{3} {f}_{- 1}^{2}} + {b}_{aB} \frac{{f}_{- 1}}{3}$$

$${σ}_{aB} = \frac{κ}{\sqrt{3}} {f}_{- 1} + ( 3 - \sqrt{3} x ) \frac{{f}_{- 1}}{3}$$

$${σ}_{aB} = {f}_{- 1} .$$

As shown above, use of strict tensor invariants may result in correctly eliminating the influence of the ratio κ of fatigue limits in fully reversed loadings on this fully reversed uniaxial load case. In some embodiments, the components of σₘ are zero, leading to the following expression:

σ_{mB}=0 MPa.

In some embodiments, the equivalent stress damage parameter may be expressed as follows:

$${D}_{P} = \sqrt{{f}_{- 1} ( {f}_{- 1} + {k}_{Berg} \cdot ( 0 MPa ) )} = {f}_{- 1} .$$

Thus, at least some embodiments of the fatigue strength model 18 disclosed herein may be substantially invariant (e.g., completely invariant). Some embodiments may also successfully reproduce repeated tension and repeated torsion fatigue limits. For brevity, only the torsion example is shown below, expressed as follows:

$$σ ( {t}_{m i n} ) = [ \begin{matrix}0 & 0 & 0 \\ 0 & 0 & 0 \\ 0 & 0 & 0\end{matrix} ] , σ ( {t}_{m ax} ) = [ \begin{matrix}0 & {t}_{0} & 0 \\ {t}_{0} & 0 & 0 \\ 0 & 0 & 0\end{matrix} ]$$

$${σ}_{a} = {σ}_{m} = \frac{1}{2} [ \begin{matrix}0 & {t}_{0} & 0 \\ {t}_{0} & 0 & 0 \\ 0 & 0 & 0\end{matrix} ] .$$

According to some embodiments, the principal stresses of the alternating stress tensor may be expressed as:

$${σ}_{1} = \frac{{t}_{0}}{2} , σ = 0 , and {σ}_{2} = - \frac{{t}_{0}}{2} .$$

The equivalent alternating and mean stress components may be expressed as follows:

$${σ}_{aB} = {a}_{aB} \sqrt{\frac{1}{6} ( {( 0 )}^{2} + {( 0 )}^{2} + {( 0 )}^{2} + 6 {( \frac{{t}_{0}}{2} )}^{2} )} + {b}_{aB} \frac{\frac{{t}_{0}}{2} + 0 - \frac{{t}_{0}}{2}}{3}$$

$${σ}_{aB} = \frac{κ {t}_{0}}{2} .$$

According to some embodiments, the equivalent stress damage parameter may be expressed as follows:

$${D}_{P} = \sqrt{\frac{κ {t}_{0}}{2} ( \frac{κ {t}_{0}}{2} + {k}_{Berg} \frac{{a}_{mB} {t}_{0}}{2} )}$$

$${D}_{P} = \sqrt{\frac{κ {t}_{0}}{2} ( \frac{κ {t}_{0}}{2} + \frac{{k}_{Berg} {t}_{0}}{2} \frac{1}{{k}_{Berg}} ( \frac{4 {f}_{- 1}^{2}}{κ {t}_{0}} - κ ) )}$$

$${D}_{P} = \sqrt{\frac{{κ}^{2} {t}_{0}^{2}}{4} ( 1 + ( \frac{4 {f}_{- 1}^{2}}{{κ}^{2} {t}_{0}^{2}} - 1 ) )}$$

$${D}_{p} = {f}_{- 1} .$$

As shown above, according to some embodiments, the fatigue strength model 18 has correctly transformed the repeated torsion case to the equivalent fully reversed uniaxial load case. As shown by the above example, the fatigue strength model 18, according to at least some embodiments, has remained invariant with respect to coordinate system orientation, and further, has maintained its four-limit-replication property.

Table 1 below shows a comparison of the fatigue limit values predicted by the above described example of the fatigue strength model 18 with experimentally observed fatigue limits, as well as other fatigue analysis methods. The fatigue limit values predicted by the above described example of the fatigue strength model 18 were compared to experimentally observed fatigue limits obtained from the FatLIM database of approximately 280 unique multiaxial non-proportional test cases with mixed direct stresses and shear stresses for comparison.

TABLE 1

| | | | | | Critical-Plane-Based | | | |
|---|---|---|---|---|---|---|---|---|
| | | | | | Method | | Integral-Based | |
| | Invariant Method | | | | | Dang | Method | |
| | Example | MMP | Crossland | Sines | PCRN++ | Van | PIR+− | LZ+− |
| | Method | Method | Method | Method | Method | Method | Method | Method |
| Maximum | 31.9% | 23.3% | 26.5% | 61.7% | 25.1% | 43.8% | 28.9% | 30.3% |
| Minimum | −30.7% | −37.7% | −61.8% | −48.8% | −12.3% | −43.6% | −15.4% | −54.6% |
| Range | 62.6% | 61.0% | 88.3% | 110.4% | 37.4% | 87.5% | 44.4% | 84.9% |
| Average | 2.0% | −2.9% | −7.8% | −3.3% | 1.8% | −2.2% | 1.9% | −1.2% |
| Standard | 8.3% | 10.0% | 14.4% | 18.7% | 6.2% | 15.9% | 7.2% | 9.3% |
| Deviation | | | | | | | | |

The accuracy of all equivalent-stress based fatigue limit estimation methods, whether critical-plane-based, integral-based, or invariant type, may be assessed using the normalized measure of error expressed as follows:

$$Δ FI = \frac{{f}_{- 1} - D}{{f}_{- 1}} ,$$

where D is the fatigue limit estimate.

Table 1 shows the results of running several modern and classic fatigue limit estimation methods, together with the fatigue strength model 18 according to embodiments of the disclosure, through the FatLIM database. Table 1 is organized by method type (invariant methods, critical-plane-based methods, or integral-based methods), which is also the general order of practicality/complexity/speed of solve, with invariant types being generally much faster than the other two types. The table columns are ordered from left to right by increasing standard deviation of the error AFI.

As shown in Table 1, the most accurate methods, those having the lowest standard deviation, by type are the fatigue strength model 18 according embodiments disclosed herein, PCRN++, which is a critical-plane-based method, and PIR+−, which is an integral-based method. Of those, PCRN++ is the most accurate, followed by PIR+−, and thereafter followed by the fatigue strength model 18 disclosed herein. Although not quite as accurate as PCRN++ and PIR+−, the fatigue strength model 18 disclosed herein is competitively close in accuracy. With a more comprehensive test case database, the fatigue strength model 18 might be found to be closer in accuracy or even more accurate. Referring to Table 1, the fatigue strength model 18 disclosed herein is more accurate than many critical-plane-based methods and many integral-based methods, especially the widely-used-in-industry Dang Van method. The MMP method shown in Table 1 is known to not be invariant, yielding different results depending on the chosen orientation of the coordinate system, greatly eroding its usefulness. Referring again to Table 1, the fatigue strength model 18 disclosed herein is shown to be relatively more accurate than at least the known invariant-type methods of the comparison.

As noted herein, the fatigue strength model 18 disclosed herein, according to at least some embodiments, is computational very efficient, resulting in the efficient use of computer resources and quick solutions. Long computational solve times associated with critical-plane-based methods and integral-based methods may be a reason such methods have not been widely adopted, even though some such methods may be very accurate.

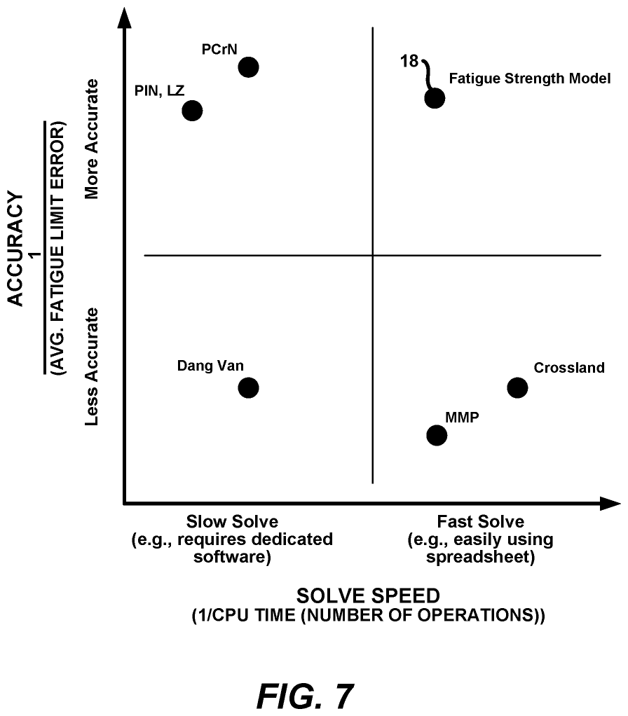

FIG. 7 graphically illustrates a comparison of accuracy and solve speed for example fatigue strengths models, including an example fatigue strength model 18, according to embodiments of the disclosure. As shown in Table 1 above and in FIG. 7, the Dang Van and Crossland methods achieve similar accuracy of results. Crossland, as an invariant method, solves the fastest of the methods in the figure, due at least in part to its relative lack of complexity. Both Dang Van and Crossland, however, have relatively poor accuracy. The critical-plane-based methods used for this comparison (PCRN++, PIR+−, LZ+−) are the most accurate shown, but are also far and away the slowest methods due to their computational complexity. After effectively disqualifying MMP, which is not coordinate system invariant, thus spoiling its accuracy, as noted above, the fatigue strength model 18 according to embodiments disclosed herein provides a uniquely practical combination of relatively high accuracy and relatively high speed of solve. Moreover, at least some embodiments of the fatigue strength method disclosed herein may be implemented in simple spreadsheet software.

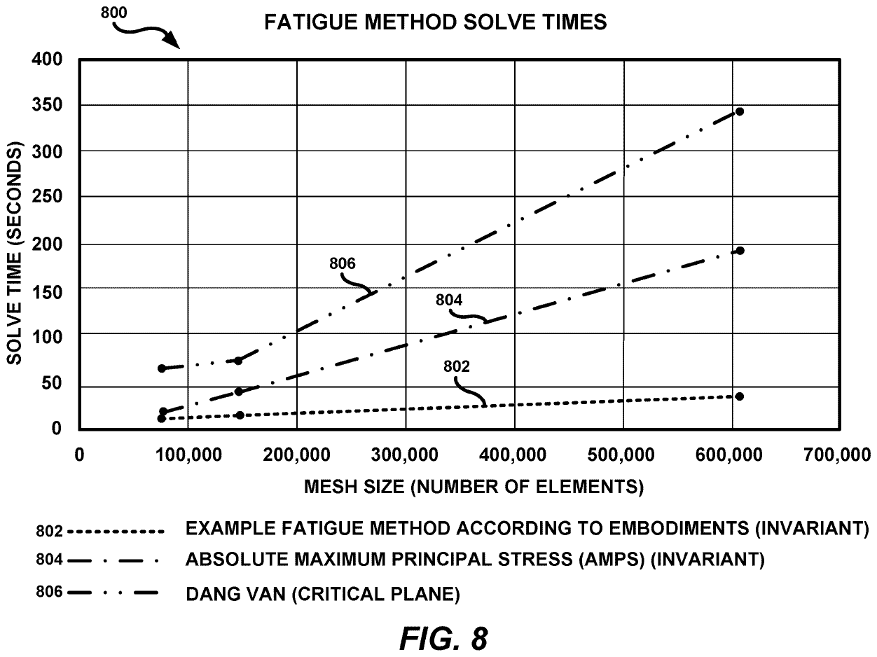

FIG. 8 is a graph 800 showing the solve time (seconds) for an example method for predicting the fatigue strength of an example component model according to embodiments of the disclosure versus the mesh size (e.g., the number of elements from a finite element analysis (FEA) generated model), and the solve times versus mesh size for the same component for two comparison fatigue strength prediction methods. The mesh sizes relate to the resolution of the results of a finite element analysis (FEA) generated model of the component, with higher mesh numbers corresponding to relatively higher resolutions, which may yield relatively more accurate results than lower mesh numbers and lower resolutions.

As shown in FIG. 8, plot 802 depicts the solve time in seconds for an example method for predicting the fatigue strength of the example component according to embodiments of the disclosure. Plot 804 depicts the solve time in seconds versus mesh size of the same example component for a first comparison fatigue strength prediction method sometimes referred to as the “absolute maximum principal stress” (AMPS) method, which is a type of fatigue analysis method sometimes referred to as an “invariant” method. Plot 806 depicts the solve time in seconds versus mesh size of the same example component for a second comparison fatigue strength prediction method sometimes referred to as the “Dang Van” method, which is a type of fatigue analysis method sometimes referred to as a “critical plane” method. For the three plots 802, 804, and 806 shown in FIG. 8, all three methods used the same computer for the purpose of comparison.

As shown in FIG. 8, in some embodiments, the example method for predicting the fatigue strength according to embodiments of the disclosure of the example component, depicted by plot 802, exhibited significantly faster solve times than both the AMPS method and the Dang Van method, for example, across a wide range of mesh sizes. For example, for a component model having a mesh size of about 100,000 elements, the example method for predicting the fatigue strength according to embodiments of the disclosure of the example component took less than about 10 seconds to solve, while the AMPS method, depicted by plot 804, took about 25 seconds to solve (i.e., over twice as long), and the Dang Van method, depicted by plot 806, took about 70 seconds to solve (i.e., about seven times as long). For a mesh size including about 300,000 elements, the example method for predicting the fatigue strength according to embodiments of the disclosure of the example component took less than about 25 seconds to solve, while the AMPS method took about 80 seconds to solve (i.e., well over three times as long), and the Dang Van method took about 170 seconds to solve (i.e., about seven times as long). For a mesh size including about 600,000 elements, the example method for predicting the fatigue strength according to embodiments of the disclosure of the example component took less than about 40 seconds to solve, while the AMPS method took about 180 seconds to solve (i.e., well over four times as long), and the Dang Van method took about 340 seconds to solve (i.e., well over eight times as long). As shown by the graph 800, as the mesh size of the model increases, the solve time advantage of the example method for predicting the fatigue strength according to embodiments of the disclosure increases, suggesting that for models having larger mesh sizes that may be used, for example, when analyzing more complex components, the example method for predicting fatigue strength according to embodiments of the disclosure will have an even more pronounced solve time advantage versus other methods, such as the AMPS method and the Dang Van method. This may result in more efficient use of computing resources, as well as reduced solve times, which may facilitate a more complete and/or more accurate fatigue analysis of a given component design.

Table 2 below shows solve times in seconds for example component models (e.g., FEA models) having respective mesh sizes for three fatigue analysis methods: (1) an example method for predicting fatigue strength according to embodiments of the disclosure, (2) the AMPS method, and (3) the Dang Van method. The example component models are for (1) a model of an example tensile specimen having a mesh size of 76,131 elements and 315,801 nodes, (2) a model of an example oilfield operational component (i.e., a fluid end block) having a relatively coarse mesh size of 146,712 elements and 245,700 nodes, and (3) a model of an example oilfield operational component (i.e., a fluid end block) having a relatively finer mesh size of 608,020 elements and 1,023,440 nodes.

TABLE 2

| | Mesh Size | | Solve Time (seconds) | | |
|---|---|---|---|---|---|
| | Number of | Number of | Example | AMPS | Dang Van |
| Model | Elements | Nodes | Method | Method | Method |
| Tensile | 76,131 | 315,701 | 13 | 18 | 67 |
| Specimen | | | | | |
| Fluid End | 146,712 | 245,700 | 15 | 41 | 75 |
| Block | | | | | |
| (coarse mesh) | | | | | |
| Fluid End | 608,020 | 1,023,440 | 36 | 194 | 345 |
| Block | | | | | |
| (fine mesh) | | | | | |

As shown in Table 2, for the example tensile specimen model, the example method for predicting fatigue strength according to embodiments of the disclosure took about 70% as long as the AMPS method to solve, and only about 20% as long as the Dang Van method to solve. For the example fluid end block model having 146,712 elements and 245,700 nodes (relatively coarse mesh), the example method for predicting fatigue strength according to embodiments of the disclosure took less than about 40% as long as the AMPS method to solve, and only about 20% as long as the Dang Van method to solve. For the example fluid end block model having 608,020 elements and 1,023,440 nodes (relatively fine mesh), the example method for predicting fatigue strength according to embodiments of the disclosure took less than about 20% as long as the AMPS method to solve, and only about 10% as long as the Dang Van method to solve. Thus, the results of this comparison indicate that as the number of elements associated with the model of the component being analyzed increases and/or the number of nodes associated with the model of the component being analyzed increases, the solve time advantage of the example method for predicting fatigue strength according to embodiments of the disclosure also increases relative to the AMPS method and the Dang Van method. As noted above, this suggests that for models having larger mesh sizes that may be used when analyzing more complex components, the example method for predicting fatigue strength according to embodiments of the disclosure will have an even more pronounced solve time advantage versus other methods, such as the AMPS method and the Dang Van method, which may result in more efficient use of computing resources, as well as reduced solve times, which may facilitate a more complete and/or more accurate fatigue analysis of a given component design.

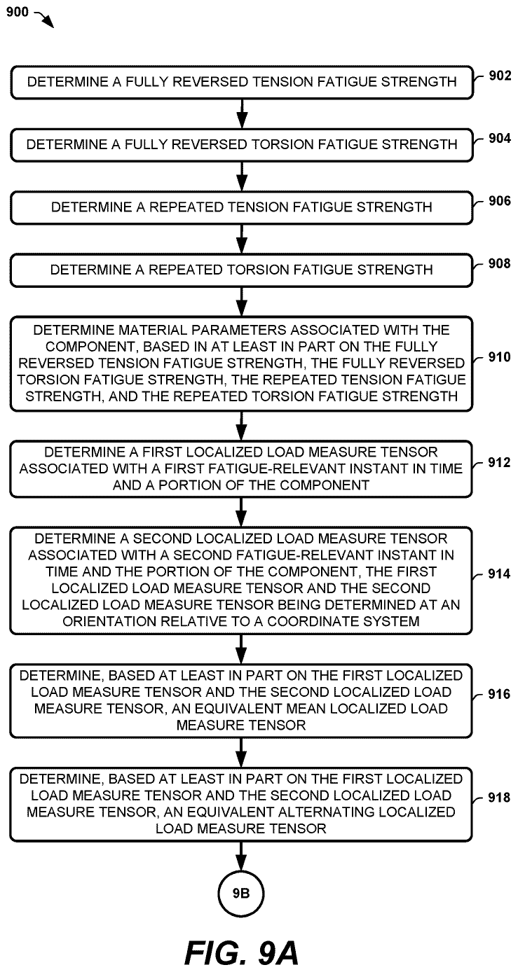

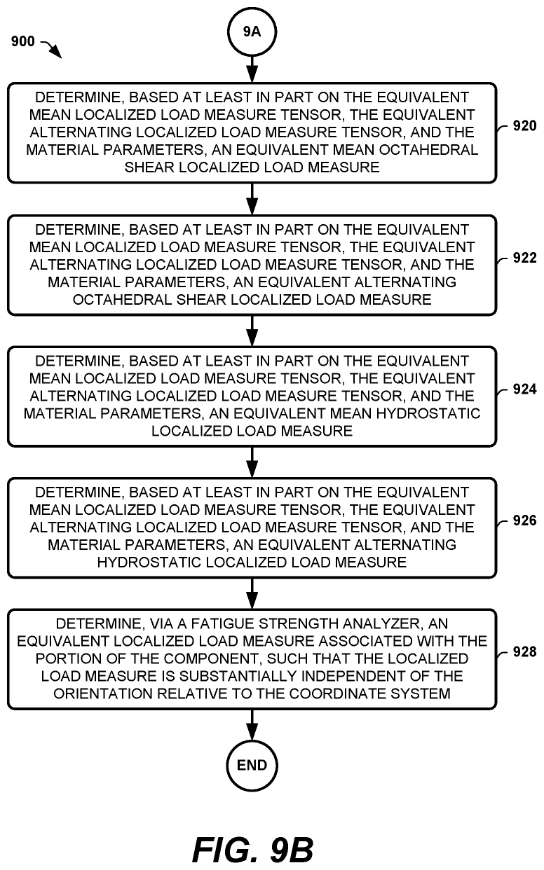

FIG. 9A and FIG. 9B are a block diagram of an example method 900 to enhance prediction of fatigue strength associated with a component, according to embodiments of the disclosure. The example method 900 is illustrated as a collection of blocks in a logical flow graph, which represent a sequence of operations. In some embodiments of the method 900, one or more of the blocks may be manually and/or automatically executed. In the context of software, where applicable, the blocks may represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described blocks can be combined in any order and/or in parallel to implement the method.

As shown in FIGS. 9A and 9B, an example method 900 to enhance prediction of fatigue strength associated with a component may include, at 902 (see FIG. 9A), determining a fully reversed tension fatigue strength, for example, as described herein.

At 904, the example method 900 may include determining a fully reversed torsion fatigue strength, for example, as described herein.

The example method 900, at 906, may include determining a repeated tension fatigue strength, for example, as described herein.

At 908, the example method 900 may include determining a repeated torsion fatigue strength, for example, as described herein.

The example method 900, at 910, may include determining material parameters associated with the component, based in at least in part on the fully reversed tension fatigue strength, the fully reversed torsion fatigue strength, the repeated tension fatigue strength, and the repeated torsion fatigue strength, for example, as described herein.

At 912, the example method 900 may include determining a first localized load measure tensor associated with a first fatigue-relevant instant in time and a portion of the component, for example, as described herein.

The example method 900, at 914, may include determining a second localized load measure tensor associated with a second fatigue-relevant instant in time and the portion of the component, the first localized load measure tensor and the second localized load measure tensor being determined at an orientation relative to a coordinate system, for example, as described herein.

At 916, the example method 900 may include determining, based at least in part on the first localized load measure tensor and the second localized load measure tensor, an equivalent mean localized load measure tensor, for example, as described herein.

The example method 900, at 918, may include determining, based at least in part on the first localized load measure tensor and the second localized load measure tensor, an equivalent alternating localized load measure tensor, for example, as described herein.

At 920 (see FIG. 9B), the example method 900 may include determining, based at least in part on the equivalent mean localized load measure tensor, the equivalent alternating localized load measure tensor, and the material parameters, an equivalent mean octahedral shear localized load measure, for example, as described herein.

The example method 900, at 922, may include determining, based at least in part on the equivalent mean localized load measure tensor, the equivalent alternating localized load measure tensor, and the material parameters, an equivalent alternating octahedral shear localized load measure, for example, as described herein.

At 924, the example method 900 may include determining, based at least in part on the equivalent mean localized load measure tensor, the equivalent alternating localized load measure tensor, and the material parameters, an equivalent mean hydrostatic localized load measure, for example, as described herein.

The example method 900, at 926, may include determining, based at least in part on the equivalent mean localized load measure tensor, the equivalent alternating localized load measure tensor, and the material parameters, an equivalent alternating hydrostatic localized load measure, for example, as described herein.

At 928, the example method 900 may include determining, via a fatigue strength analyzer, an equivalent localized load measure associated with the portion of the component, such that the equivalent localized load measure is substantially independent of the orientation relative to the coordinate system, for example, as described herein. The equivalent localized load measure associated with the portion of the component may be determined based at least in part on one or more of: (a) the equivalent mean octahedral localized load measure, (b) the equivalent alternating octahedral localized load measure, (c) the equivalent mean hydrostatic localized load measure, (d) the equivalent alternating hydrostatic localized load measure, or (e) the material parameters, for example, as described herein. Thereafter, the example method 900 may end or be repeated.

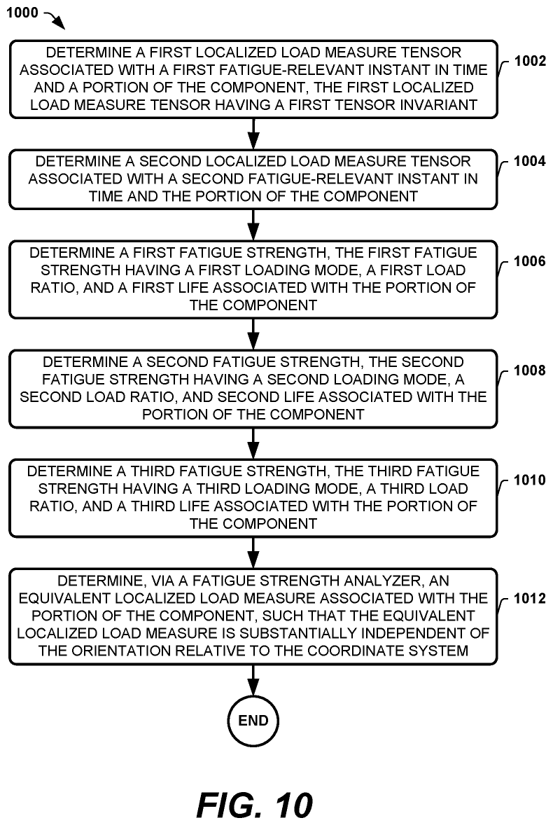

FIG. 10 is a block diagram of an example method 1000 to enhance prediction of fatigue strength associated with a component, according to embodiments of the disclosure. The example method 1000 is illustrated as a collection of blocks in a logical flow graph, which represent a sequence of operations. In some embodiments of the method 1000, one or more of the blocks may be manually and/or automatically executed. In the context of software, where applicable, the blocks may represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described blocks can be combined in any order and/or in parallel to implement the method.

As shown in FIG. 10, an example method 1000 to enhance prediction of fatigue strength associated with a component may include, at 1002, determining a first localized load measure tensor associated with a first fatigue-relevant instant in time and a portion of the component, the first localized load measure tensor having a first tensor invariant, for example, as described herein.

At 1004, the example method 1000 may include determining a second localized load measure tensor associated with a second fatigue-relevant instant in time and the portion of the component, for example, as described herein. In some embodiments, the second localized load measure tensor may have a second tensor invariant, one of the first localized load measure tensor or the second localized load measure tensor may have a third tensor invariant, the third tensor invariant being non-collinear relative to one of the first tensor invariant or the second tensor invariant of the one of the first localized load measure tensor or the second localized load measure tensor, and the first localized load measure tensor and the second localized load measure tensor may be determined at an orientation relative to a coordinate system, for example, as described herein.

The example method 1000, at 1006, may include determining a first fatigue strength, the first fatigue strength being a single-load-mode fatigue strength and having a first loading mode, a first load ratio, and a first life associated with the portion of the component, for example, as described herein.

At 1008, the example method 1000 may include determining a second fatigue strength, the second fatigue strength being a single-load-mode fatigue strength and having a second loading mode, a second load ratio, and second life associated with the portion of the component, for example, as described herein.

The example method 1000, at 1010, may include determining a third fatigue strength, the third fatigue strength being a single-load-mode fatigue strength and having a third loading mode, a third load ratio, and a third life associated with the portion of the component, for example, as described herein.

At 1012, the example method 1000 may include determining, via a fatigue strength analyzer and based at least in part on the first tensor invariant, the second tensor invariant, the third tensor invariant, the first fatigue strength, the second fatigue strength, and the third fatigue strength, an equivalent localized load measure associated with the portion of the component, such that the equivalent localized load measure is substantially independent of the orientation relative to the coordinate system, for example, as described herein. Thereafter, the example method 1000 may end or be repeated.

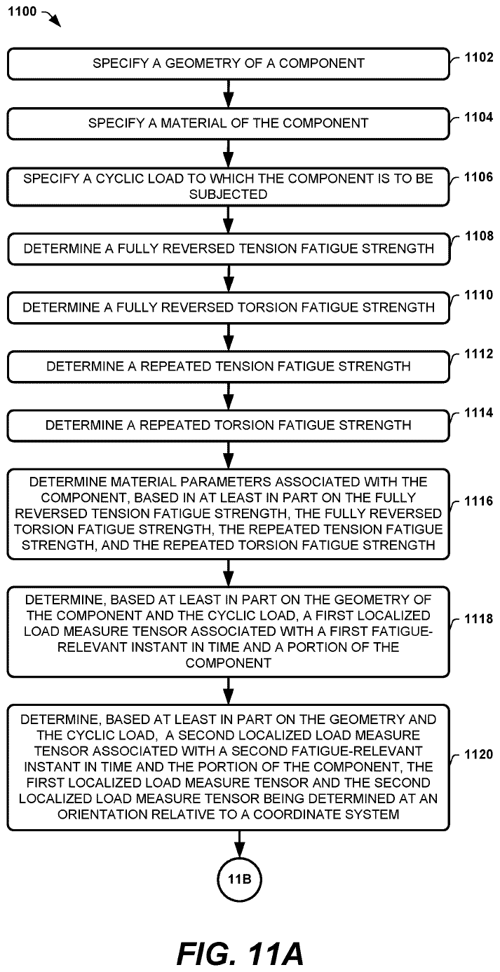

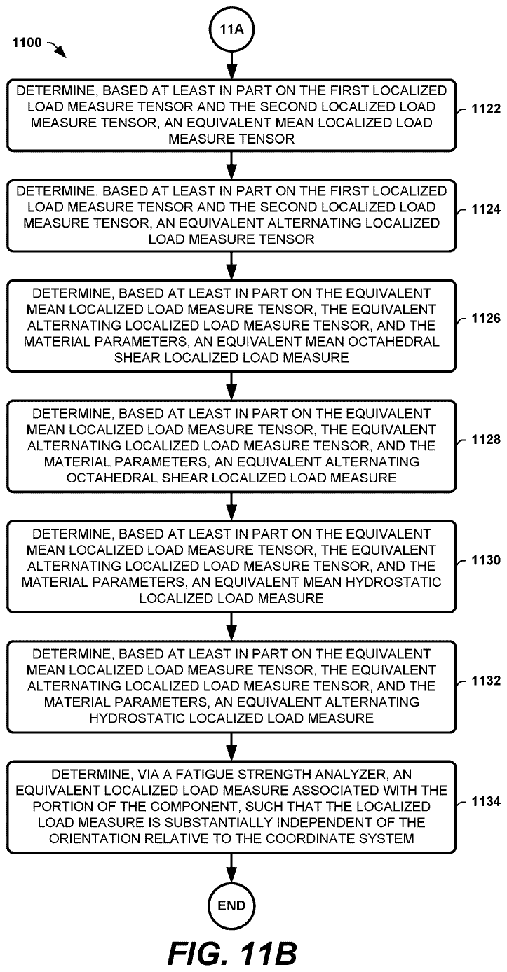

FIG. 11A and FIG. 11B are a block diagram of an example method 1100 to enhance design of a component, according to embodiments of the disclosure. The example method 1100 is illustrated as a collection of blocks in a logical flow graph, which represent a sequence of operations. In some embodiments of the method 1100, one or more of the blocks may be manually and/or automatically executed. In the context of software, where applicable, the blocks may represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described blocks can be combined in any order and/or in parallel to implement the method.

As shown in FIGS. 11A and 11B, an example method 1100 to enhance design of a component may include, at 1102 (see FIG. 11A), specifying a geometry of a component, for example, as described herein.

At 1104, the example method 1100 may include specifying a material of the component, for example, as described herein.

The example method 1100, at 1106, may include specifying a cyclic load to which the component is to be subjected, for example, as described herein.

At 1108, the example method 1100 may include determining a fully reversed tension fatigue strength, for example, as described herein.

The example method 1100, at 1110, may include determining a fully reversed torsion fatigue strength, for example, as described herein.

At 1112, the example method 1100 may include determining a repeated tension fatigue strength, for example, as described herein.

The example method 1100, at 1114, may include determining a repeated torsion fatigue strength, for example, as described herein.

At 1116, the example method 1100 may include determining material parameters associated with the component, based in at least in part on the fully reversed tension fatigue strength, the fully reversed torsion fatigue strength, the repeated tension fatigue strength, and the repeated torsion fatigue strength, for example, as described herein.

The example method 1100, at 1118, may include determining, based at least in part on the geometry of the component and the cyclic load, a first localized load measure tensor associated with a first fatigue-relevant instant in time and a portion of the component, for example, as described herein.

At 1120, the example method 1100 may include determining, based at least in part on the geometry and the cyclic load, a second localized load measure tensor associated with a second fatigue-relevant instant in time and the portion of the component, the first localized load measure tensor and the second localized load measure tensor being determined at an orientation relative to a coordinate system determining, for example, as described herein.

The example method 1100, at 1122 (see FIG. 11B), may include determining, based at least in part on the first localized load measure tensor and the second localized load measure tensor, an equivalent mean localized load measure tensor, for example, as described herein.

The example method 1100, at 1124, may include determining, based at least in part on the first localized load measure tensor and the second localized load measure tensor, an equivalent alternating localized load measure tensor, for example, as described herein.

At 1126, the example method 1100 may include determining, based at least in part on the equivalent mean localized load measure tensor, the equivalent alternating localized load measure tensor, and the material parameters, an equivalent mean octahedral shear localized load measure, for example, as described herein.

The example method 1100, at 1128, may include determining, based at least in part on the equivalent mean localized load measure tensor, the equivalent alternating localized load measure tensor, and the material parameters, an equivalent alternating octahedral shear localized load measure, for example, as described herein.

At 1130, the example method 1100 may include determining, based at least in part on the equivalent mean localized load measure tensor, the equivalent alternating localized load measure tensor, and the material parameters, an equivalent mean hydrostatic localized load measure, for example, as described herein.

The example method 1100, at 1132, may include determining, based at least in part on the equivalent mean localized load measure tensor, the equivalent alternating localized load measure tensor, and the material parameters, an equivalent alternating hydrostatic localized load measure, for example, as described herein.

The example method 1100, at 1134, may include determining, via a fatigue strength analyzer, an equivalent localized load measure associated with the portion of the component, such that the equivalent localized load measure is substantially independent of the orientation relative to the coordinate system, for example, as described herein. The equivalent localized load measure associated with the portion of the component may be determined based at least in part on one or more of: (a) the equivalent mean octahedral localized load measure, (b) the equivalent alternating octahedral localized load measure, (c) the equivalent mean hydrostatic localized load measure, (d) the equivalent alternating hydrostatic localized load measure, or (e) the material parameters, for example, as described herein. Thereafter, the example method 1100 may end or be repeated.

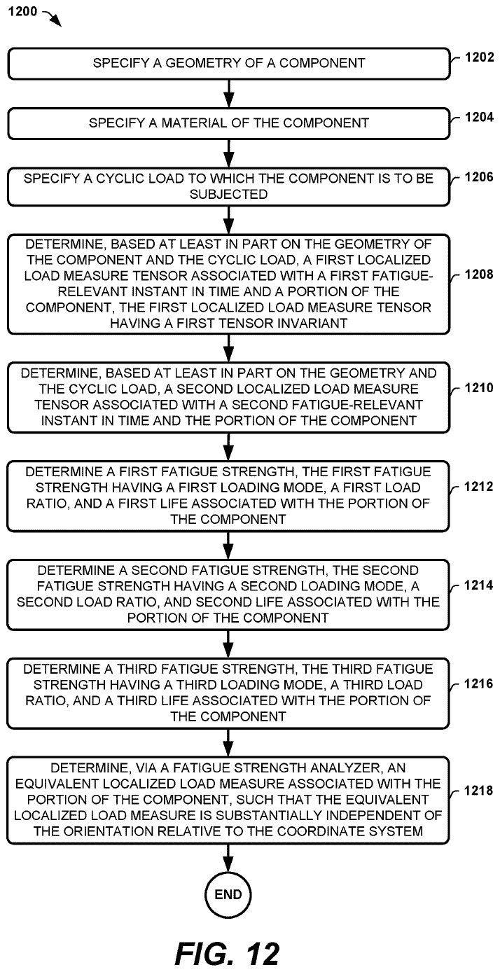

FIG. 12 is a block diagram of an example method 1200 to enhance design of a component, according to embodiments of the disclosure. The example method 1200 is illustrated as a collection of blocks in a logical flow graph, which represent a sequence of operations. In some embodiments of the method 1200, one or more of the blocks may be manually and/or automatically executed. In the context of software, where applicable, the blocks may represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described blocks can be combined in any order and/or in parallel to implement the method.

As shown in FIG. 12, an example method 1200 to enhance design of a component may include, at 1202, specifying a geometry of a component, for example, as described herein.

At 1204, the example method 1200 may include specifying a material of the component, for example, as described herein.

The example method 1200, at 1206, may include specifying a cyclic load to which the component is to be subjected, for example, as described herein.

At 1208, the example method 1200 may include determining, based at least in part on the geometry of the component and the cyclic load, a first localized load measure tensor associated with a first fatigue-relevant instant in time and a portion of the component, the first localized load measure tensor having a first tensor invariant, for example, as described herein.

The example method 1200, at 1210, may include determining, based at least in part on the geometry and the cyclic load, a second localized load measure tensor associated with a second fatigue-relevant instant in time and the portion of the component, the second localized load measure tensor having a second tensor invariant, for example, as described herein. In some embodiments, one of the first localized load measure tensor or the second localized load measure tensor may have a third tensor invariant, the third tensor invariant being non-collinear relative to one of the first tensor invariant or the second tensor invariant of the one of the first localized load measure tensor or the second localized load measure tensor, and the first localized load measure tensor and the second localized load measure tensor being determined at an orientation relative to a coordinate system, for example, as described herein.

At 1212, the example method 1200 may include determining a first fatigue strength, the first fatigue strength being a single-load-mode fatigue strength and having a first loading mode, a first load ratio, and a first life associated with the portion of the component, for example, as described herein.

The example method 1200, at 1214, may include determining a second fatigue strength, the second fatigue strength being a single-load-mode fatigue strength and having a second loading mode, a second load ratio, and second life associated with the portion of the component, for example, as described herein.

At 1216, the example method 1200 may include determining a third fatigue strength, the third fatigue strength being a single-load-mode fatigue strength and having a third loading mode, a third load ratio, and a third life associated with the portion of the component, for example, as described herein.

The example method 1200, at 1218, may include determining, via a fatigue strength analyzer, an equivalent localized load measure associated with the portion of the component, such that the equivalent localized load measure is substantially independent of the orientation relative to the coordinate system, for example, as described herein. In some embodiments, the equivalent localized load measure associated with the portion of the component may be determined based on one or more of the first tensor invariant, the second tensor invariant, the third tensor invariant, the first fatigue strength, the second fatigue strength, and the third fatigue strength, for example, as described herein. Thereafter, the example method 1200 may end or be repeated.

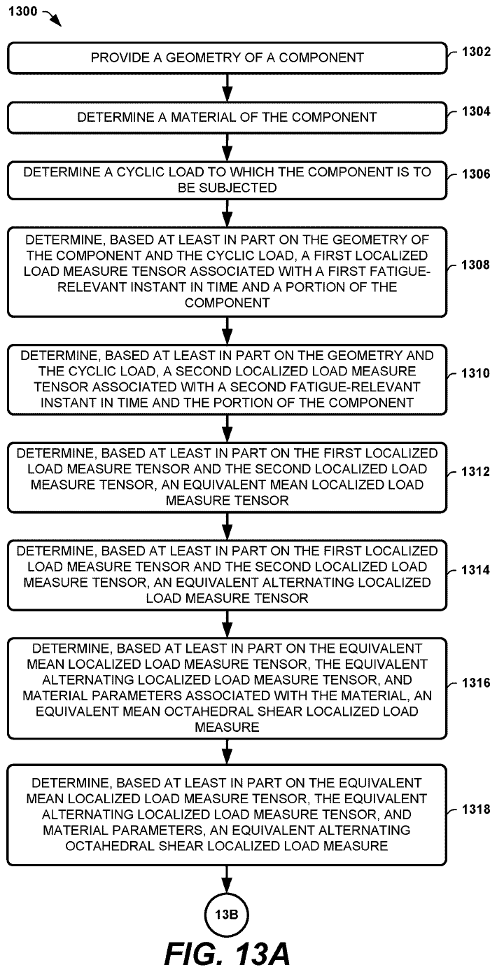

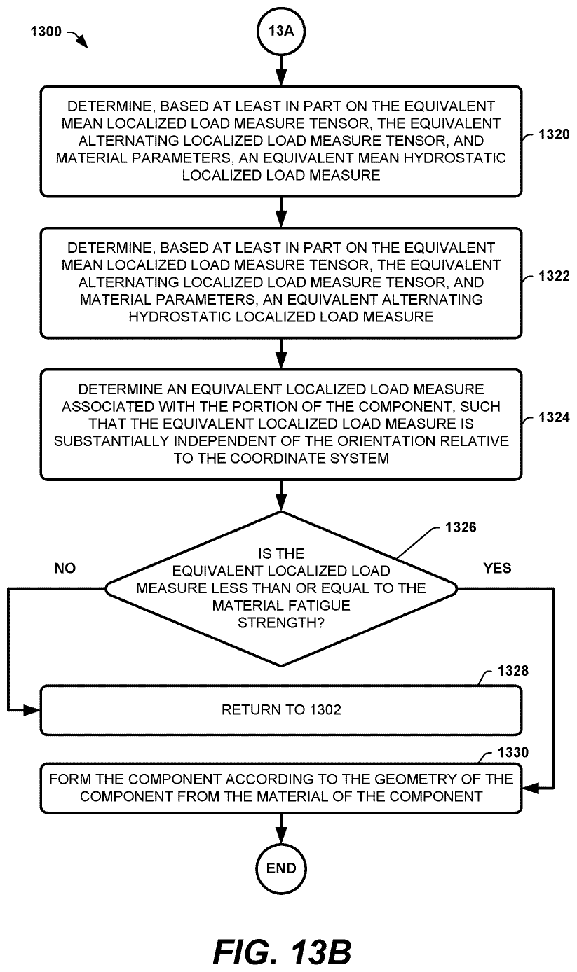

FIG. 13A and FIG. 13B are a block diagram of an example method 1300 of enhancing manufacture of a component, according to embodiments of the disclosure. The example method 1300 is illustrated as a collection of blocks in a logical flow graph, which represent a sequence of operations. In some embodiments of the method 1300, one or more of the blocks may be manually and/or automatically executed. In the context of software, where applicable, the blocks may represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described blocks can be combined in any order and/or in parallel to implement the method.

As shown in FIGS. 13A and 13B, an example method 1300 of enhancing manufacture of a component may include, at 1302 (see FIG. 13A), providing a geometry for the component, for example, as described herein. In some embodiments of the example method 1300, the example method 1300 may include one or more of: (a) determining a first fatigue strength, the first fatigue strength being a single-load-mode fatigue strength and having a first loading mode, a first load ratio, and a first life associated with the portion of the component; (b) determining a second fatigue strength, the second fatigue strength being a single-load-mode fatigue strength and having a second loading mode, a second load ratio, and second life associated with the portion of the component; or (c) determining a third fatigue strength, the third fatigue strength being a single-load-mode fatigue strength and having a third loading mode, a third load ratio, and a third life associated with the portion of the component, for example, as described herein.

At 1304, the example method 1300 may include determining a material of the component, the material having a material fatigue strength, for example, as described herein.

The example method 1300, at 1306, may include determining a cyclic load to which the component is to be subjected, for example, as described herein.

At 1308, the example method 1300 may include determining, based at least in part on the geometry of the component and the cyclic load, a first localized load measure tensor associated with a first fatigue-relevant instant in time and a portion of the component, for example, as described herein.

The example method 1300, at 1310, may include determining, based at least in part on the geometry and the cyclic load, a second localized load measure tensor associated with a second fatigue-relevant instant in time and the portion of the component, the first localized load measure tensor and the second localized load measure tensor being determined at an orientation relative to a coordinate system, for example, as described herein.

At 1312, the example method 1300 may include determining, based at least in part on the first localized load measure tensor and the second localized load measure tensor, an equivalent mean localized load measure tensor, for example, as described herein.

The example method 1300, at 1314, may include determining, based at least in part on the first localized load measure tensor and the second localized load measure tensor, an equivalent alternating localized load measure tensor, for example, as described herein.

At 1316, the example method 1300 may include determining, based at least in part on the equivalent mean localized load measure tensor, the equivalent alternating localized load measure tensor, and material parameters associated with the material, an equivalent mean octahedral shear localized load measure, for example, as described herein.

The example method 1300, at 1318, may include determining, based at least in part on the equivalent mean localized load measure tensor, the equivalent alternating localized load measure tensor, and material parameters, an equivalent alternating octahedral shear localized load measure, for example, as described herein.

At 1320 (see FIG. 13B), the example method 1300 may include determining, based at least in part on the equivalent mean localized load measure tensor, the equivalent alternating localized load measure tensor, and material parameters, an equivalent mean hydrostatic localized load measure, for example, as described herein.

The example method 1300, at 1322, may include determining, based at least in part on the equivalent mean localized load measure tensor, the equivalent alternating localized load measure tensor, and material parameters, an equivalent alternating hydrostatic localized load measure, for example, as described herein.

At 1324, the example method 1300 may include determining, via a fatigue strength analyzer, an equivalent localized load measure associated with the portion of the component, such that the equivalent localized load measure is substantially independent of the orientation relative to the coordinate system, for example, as described herein. The equivalent localized load measure associated with the portion of the component may be determined based at least in part on one or more of: (a) the equivalent mean octahedral localized load measure, (b) the equivalent alternating octahedral localized load measure, (c) the equivalent mean hydrostatic localized load measure, (d) the equivalent alternating hydrostatic localized load measure, or (e) the material parameters, for example, as described herein.

The example method 1300, at 1326, may include determining whether the equivalent localized load measure is less than or equal to the material fatigue strength, for example, as described herein.

If, at 1326, it is determined that the equivalent localized load measure is not less than or equal to the material fatigue strength, at 1328, the example method 1300 may include returning to 1302 and providing (or specifying) a different geometry for the component, determining (or specifying) a different material or materials for the component, and/or determining (or specifying) a different cyclic load for the component.

If, at 1326, it is determined that the equivalent localized load measure is less than or equal to the material fatigue strength, at 1330, the example method 1300 may include forming the component according to the geometry of the component from the material of the component. Thereafter, the example method 1300 may end or be repeated.

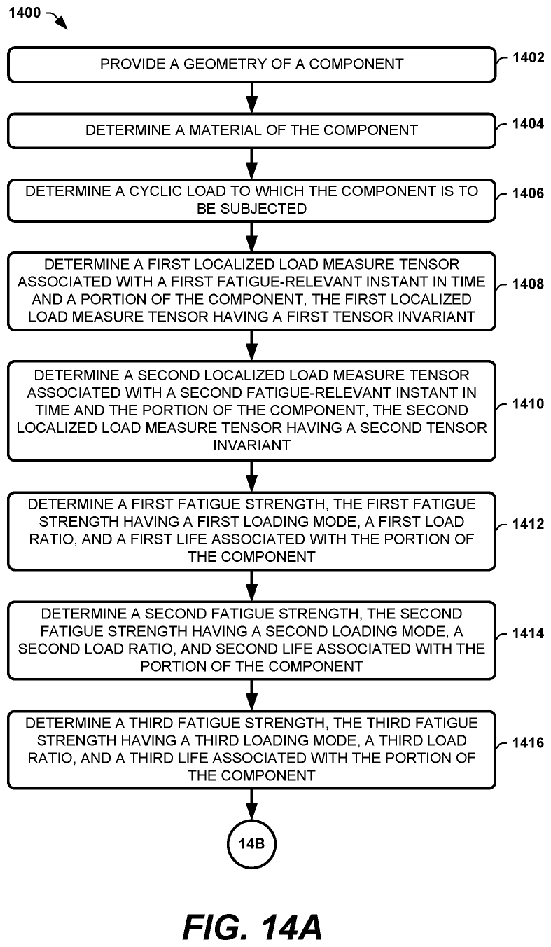

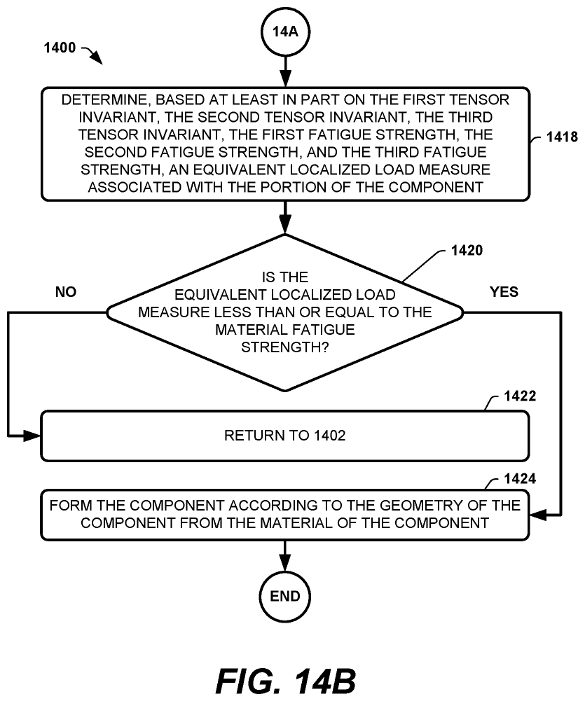

FIG. 14A and FIG. 14B are a block diagram of an example method 1400 of enhancing manufacture of a component, according to embodiments of the disclosure. The example method 1400 is illustrated as a collection of blocks in a logical flow graph, which represent a sequence of operations. In some embodiments of the method 1400, one or more of the blocks may be manually and/or automatically executed. In the context of software, where applicable, the blocks may represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described blocks can be combined in any order and/or in parallel to implement the method.

As shown in FIGS. 14A and 14B, an example method 1400 of enhancing manufacture of a component may include, at 1402 (see FIG. 14A), providing a geometry for the component, for example, as described herein.

At 1404, the example method 1400 may include determining a material of the component, the material having a material fatigue strength, for example, as described herein.

The example method 1400, at 1406, may include determining a cyclic load to which the component is to be subjected, for example, as described herein.

At 1408, the example method 1400 may include determining a first localized load measure tensor associated with a first fatigue-relevant instant in time and a portion of the component, the first localized load measure tensor having a first tensor invariant, for example, as described herein.

The example method 1400, at 1410, may include determining a second localized load measure tensor associated with a second fatigue-relevant instant in time and the portion of the component, the second localized load measure tensor having a second tensor invariant, for example, as described herein. In some embodiments, one of the first localized load measure tensor or the second localized load measure tensor may have a third tensor invariant, the third tensor invariant being non-collinear relative to one of the first tensor invariant or the second tensor invariant of the one of the first localized load measure tensor or the second localized load measure tensor, and the first localized load measure tensor and the second localized load measure tensor being determined at an orientation relative to a coordinate system.

At 1412, the example method 1400 may include determining a first fatigue strength, the first fatigue strength being a single-load-mode fatigue strength and having a first loading mode, a first load ratio, and a first life associated with the portion of the component, for example, as described herein.

The example method 1400, at 1414, may include determining a second fatigue strength, the second fatigue strength being a single-load-mode fatigue strength and having a second loading mode, a second load ratio, and second life associated with the portion of the component, for example, as described herein.

At 1416, the example method 1400 may include determining a third fatigue strength, the third fatigue strength being a single-load-mode fatigue strength and having a third loading mode, a third load ratio, and a third life associated with the portion of the component, for example, as described herein.

The example method 1400, at 1418 (see FIG. 14B), may include determining, based at least in part on the first tensor invariant, the second tensor invariant, the third tensor invariant, the first fatigue strength, the second fatigue strength, and the third fatigue strength, an equivalent localized load measure associated with the portion of the component, such that the equivalent localized load measure is substantially independent of the orientation relative to the coordinate system, for example, as described herein.

At 1420, the example method 1400 may include determining whether the equivalent localized load measure is less than or equal to the material fatigue strength, for example, as described herein.

If, at 1420, it is determined that the equivalent localized load measure is not less than or equal to the material fatigue strength, at 1422, the example method 1400 may include returning to 1402 and providing (or specifying) a different geometry for the component, determining (or specifying) a different material or materials for the component, and/or determining (or specifying) a different cyclic load for the component.

If, at 1420, it is determined that the equivalent localized load measure is less than or equal to the material fatigue strength, at 1424, the example method 1400 may include forming the component according to the geometry of the component from the material of the component. Thereafter, the example method 1400 may end or be repeated.

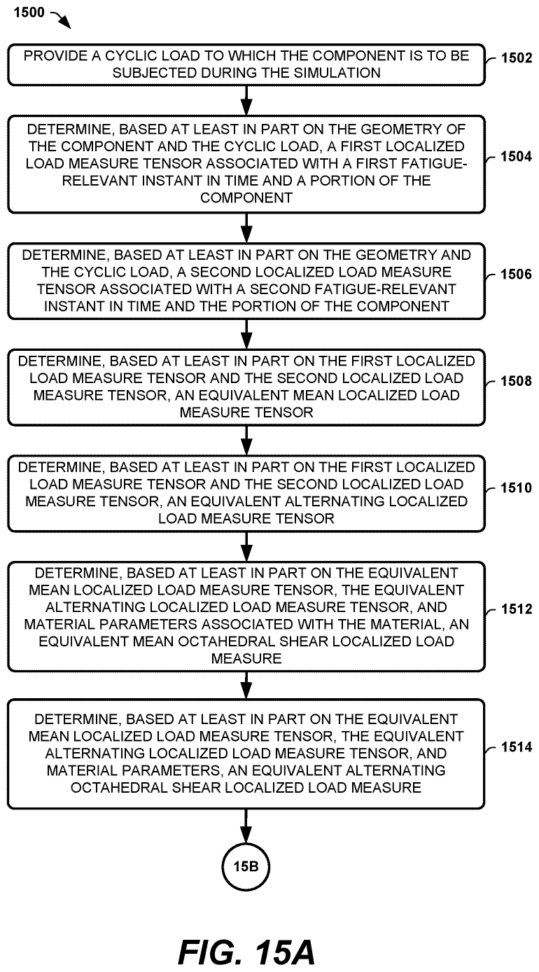

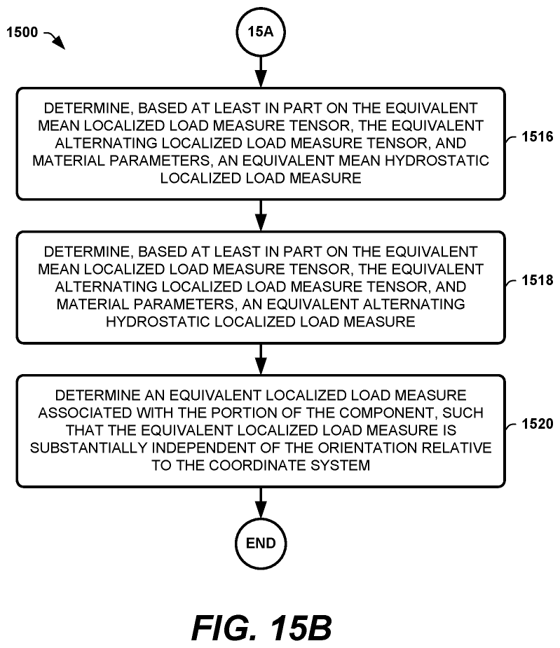

FIG. 15A and FIG. 15B are a block diagram of an example method 1500 for enhancing simulation of effects of cyclic loading on a component having a component geometry and being formed from a component material having a material fatigue strength, according to embodiments of the disclosure. The example method 1500 is illustrated as a collection of blocks in a logical flow graph, which represent a sequence of operations. In some embodiments of the method 1500, one or more of the blocks may be manually and/or automatically executed. In the context of software, where applicable, the blocks may represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described blocks can be combined in any order and/or in parallel to implement the method.

As shown in FIGS. 15A and 15B, an example method 1500 for enhancing simulation of effects of cyclic loading on a component having a component geometry and being formed from a component material having a material fatigue strength, may include, at 1502 (see FIG. 15A), providing a cyclic load to which the component is to be subjected during the simulation, for example, as described herein. In some embodiments of the example method 1500, the example method 1500 may include one or more of: (a) determining a first fatigue strength, the first fatigue strength being a single-load-mode fatigue strength and having a first loading mode, a first load ratio, and a first life associated with the portion of the component; (b) determining a second fatigue strength, the second fatigue strength being a single-load-mode fatigue strength and having a second loading mode, a second load ratio, and second life associated with the portion of the component; or (c) determining a third fatigue strength, the third fatigue strength being a single-load-mode fatigue strength and having a third loading mode, a third load ratio, and a third life associated with the portion of the component, for example, as described herein.

At 1504, the example method 1500 may include determining, based at least in part on the geometry of the component and the cyclic load, a first localized load measure tensor associated with a first fatigue-relevant instant in time and a portion of the component, for example, as described herein.

The example method 1500, at 1506, may include determining, based at least in part on the geometry and the cyclic load, a second localized load measure tensor associated with a second fatigue-relevant instant in time and the portion of the component, the first localized load measure tensor and the second localized load measure tensor being determined at an orientation relative to a coordinate system, for example, as described herein.

At 1508, the example method 1500 may include determining, based at least in part on the first localized load measure tensor and the second localized load measure tensor, an equivalent mean localized load measure tensor, for example, as described herein.

The example method 1500, at 1510, may include determining, based at least in part on the first localized load measure tensor and the second localized load measure tensor, an equivalent alternating localized load measure tensor, for example, as described herein.

At 1512, the example method 1500 may include determining, based at least in part on the equivalent mean localized load measure tensor, the equivalent alternating localized load measure tensor, and material parameters associated with the component material, an equivalent mean octahedral shear localized load measure, for example, as described herein.

The example method 1500, at 1514, may include determining, based at least in part on the equivalent mean localized load measure tensor, the equivalent alternating localized load measure tensor, and the material parameters, an equivalent alternating octahedral shear localized load measure, for example, as described herein.

At 1516 (see FIG. 15B), the example method 1500 may include determining, based at least in part on the equivalent mean localized load measure tensor, the equivalent alternating localized load measure tensor, and the material parameters, an equivalent mean hydrostatic localized load measure, for example, as described herein.

The example method 1500, at 1518, may include determining, based at least in part on the equivalent mean localized load measure tensor, the equivalent alternating localized load measure tensor, and the material parameters, an equivalent alternating hydrostatic localized load measure, for example, as described herein.

At 1520, the example method 1500 may include determining, via a fatigue strength analyzer, an equivalent localized load measure associated with the portion of the component, such that the equivalent localized load measure is substantially independent of the orientation relative to the coordinate system, for example, as described herein. The equivalent localized load measure associated with the portion of the component may be determined based at least in part on one or more of: (a) the equivalent mean octahedral localized load measure, (b) the equivalent alternating octahedral localized load measure, (c) the equivalent mean hydrostatic localized load measure, (d) the equivalent alternating hydrostatic localized load measure, or (e) the material parameters, for example, as described herein. Thereafter, the example method 1500 may end or be repeated.

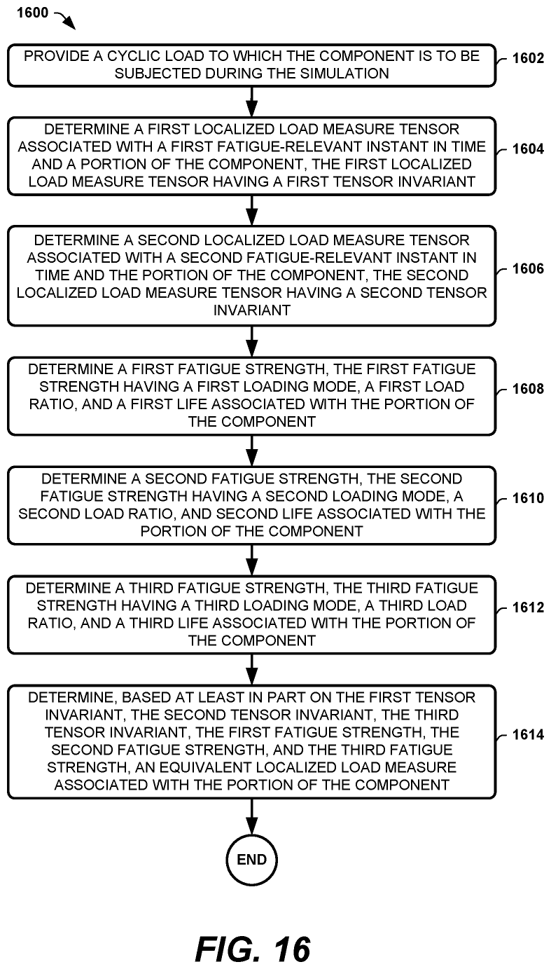

FIG. 16 is a block diagram of an example method 1600 for enhancing simulation of effects of cyclic loading on a component having a component geometry and being formed from a component material having a material fatigue strength, according to embodiments of the disclosure. The example method 1600 is illustrated as a collection of blocks in a logical flow graph, which represent a sequence of operations. In some embodiments of the method 1600, one or more of the blocks may be manually and/or automatically executed. In the context of software, where applicable, the blocks may represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described blocks can be combined in any order and/or in parallel to implement the method.

As shown in FIG. 16, an example method 1600 for enhancing simulation of effects of cyclic loading on a component having a component geometry and being formed from a component material having a material fatigue strength, may include, at 1602, providing a cyclic load to which the component is to be subjected during the simulation, for example, as described herein.

At 1604, the example method 1600 may include determining, based at least in part on the geometry of the component and the cyclic load, a first localized load measure tensor associated with a first fatigue-relevant instant in time and a portion of the component, the first localized load measure tensor having a first tensor invariant, for example, as described herein.

The example method 1600, at 1606, may include determining a second localized load measure tensor associated with a second fatigue-relevant instant in time and the portion of the component, the second localized load measure tensor having a second tensor invariant, for example, as described herein. In some embodiments, one of the first localized load measure tensor or the second localized load measure tensor may have a third tensor invariant, the third tensor invariant being non-collinear relative to one of the first tensor invariant or the second tensor invariant of the one of the first localized load measure tensor or the second localized load measure tensor, and the first localized load measure tensor and the second localized load measure tensor being determined at an orientation relative to a coordinate system, for example, as described herein.

At 1608, the example method 1600 may include determining a first fatigue strength, the first fatigue strength being a single-load-mode fatigue strength and having a first loading mode, a first load ratio, and a first life associated with the portion of the component, for example, as described herein.

The example method 1600, at 1610, may include determining a second fatigue strength, the second fatigue strength being a single-load-mode fatigue strength and having a second loading mode, a second load ratio, and second life associated with the portion of the component, for example, as described herein.

At 1612, the example method 1600 may include determining a third fatigue strength, the third fatigue strength being a single-load-mode fatigue strength and having a third loading mode, a third load ratio, and a third life associated with the portion of the component, for example, as described herein.

The example method 1600, at 1614, may include determining, based at least in part on the first tensor invariant, the second tensor invariant, the third tensor invariant, the first fatigue strength, the second fatigue strength, and the third fatigue strength, an equivalent localized load measure associated with the portion of the component, such that the equivalent localized load measure is substantially independent of the orientation relative to the coordinate system, for example, as described herein. Thereafter, the example method 1600 may end or be repeated.

It should be appreciated that at least some subject matter presented herein may be implemented as a computer process, a computer-controlled apparatus, a computing system, or an article of manufacture, such as a computer-readable storage medium. While the subject matter described herein is presented in the general context of program modules that execute on one or more computing devices, those skilled in the art will recognize that other implementations may be performed in combination with other types of program modules. Generally, program modules include routines, programs, components, data structures, and other types of structures that perform particular tasks or implement particular abstract data types.

Those skilled in the art will also appreciate that aspects of the subject matter described herein may be practiced on or in conjunction with other computer system configurations beyond those described herein, including multiprocessor systems, microprocessor-based or programmable consumer electronics, minicomputers, mainframe computers, handheld computers, mobile telephone devices, tablet computing devices, special-purposed hardware devices, network appliances, and the like.

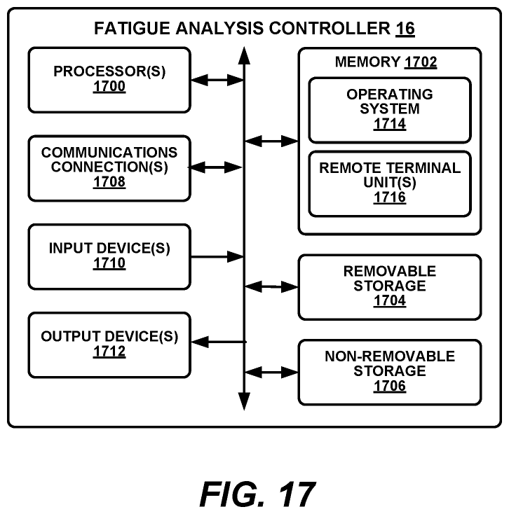

FIG. 17 is a schematic diagram of an example fatigue analysis controller 16 configured to enhance prediction of fatigue-related characteristics associated with a component and/or to enhance control of manufacturing associated with components, as well as possible other uses, according to embodiments of the disclosure. The fatigue analysis controller 16 may include one or more of the controllers described herein. The fatigue analysis controller 16 may include one or more processor(s) 1700 configured to execute certain operational aspects associated with implementing certain systems and methods described herein. The processor(s) 1700 may communicate with a memory 1702. The processor(s) 1700 may be implemented and operated using appropriate hardware, software, firmware, or combinations thereof. Software or firmware implementations may include computer-executable or machine-executable instructions written in any suitable programming language to perform the various functions described. In some examples, instructions associated with a function block language may be stored in the memory 1702 and executed by the processor(s) 1700.

The memory 1702 may be used to store program instructions that are loadable and executable by the processor(s) 1700, as well as to store data generated during the execution of these programs. Depending on the configuration and type of the fatigue analysis controller 16, the memory 1702 may be volatile (such as random access memory (RAM)) and/or non-volatile (such as read-only memory (ROM), flash memory, etc.). In some examples, the memory devices may include additional removable storage 1704 and/or non-removable storage 1706 including, but not limited to, magnetic storage, optical disks, and/or tape storage. The disk drives and their associated computer readable media may provide non-volatile storage of computer-readable instructions, data structures, program modules, and other data for the devices. In some implementations, the memory 1702 may include multiple different types of memory, such as static random access memory (SRAM), dynamic random access memory (DRAM), or ROM.

The memory 1702, the removable storage 1704, and the non-removable storage 1706 are all examples of computer-readable storage media. For example, computer-readable storage media may include volatile and non-volatile, removable, and non-removable media implemented in any method or technology for storage of information, such as computer-readable instructions, data structures, program modules, or other data. Additional types of computer storage media that may be present may include, but are not limited to, programmable random access memory (PRAM), SRAM, DRAM, RAM, ROM, electrically erasable programmable read-only memory (EEPROM), flash memory, or other memory technology, compact disc read-only memory (CD-ROM), digital versatile discs (DVD) or other optical storage, magnetic cassettes, magnetic tapes, magnetic disk storage or other magnetic storage devices, or any other medium, which may be used to store the desired information and which may be accessed by the devices. Combinations of any of the above should also be included within the scope of computer-readable media.

The fatigue analysis controller 16 may also include one or more communication connection(s) 1708 that may facilitate a control device (not shown) to communicate with devices or equipment capable of communicating with the fatigue analysis controller 16. The fatigue analysis controller 16 may also include a computer system (not shown). Connections may also be established via various data communication channels or ports, such as USB or COM ports to receive cables connecting the fatigue analysis controller 16 to various other devices on a network. In some examples, the fatigue analysis controller 16 may include Ethernet drivers that enable the fatigue analysis controller 16 to communicate with other devices on the network. According to various examples, communication connections 1708 may be established via a wired and/or wireless connection on the network.

The fatigue analysis controller 16 also may include one or more input devices 1710, such as a keyboard, mouse, pen, voice input device, gesture input device, and/or touch input device. It may further include one or more output devices 1712, such as a display, printer, and/or speakers. In some examples, computer-readable communication media may include computer-readable instructions, program modules, or other data transmitted within a data signal, such as a carrier wave or other transmission. As used herein, however, computer-readable storage media may not include computer-readable communication media.

Turning to the contents of the memory 1702, the memory 1702 may include, but is not limited to, an operating system (OS) 1714 and one or more application programs or services for implementing the features and embodiments disclosed herein. Such applications or services may include remote terminal unit(s) 1716 for executing certain systems and methods described herein, for example, upon receipt of one or more control signals generated by the fatigue analysis controller 16. In some embodiments, one or more remote terminal unit(s) 1716 may be located on one or more components of the fatigue analysis controller 16. The remote terminal unit(s) 1716 may reside in the memory 1702 or may be independent of the fatigue analysis controller 16. In some examples, the remote terminal unit(s) 1716 may be implemented by software that may be provided in configurable control block language and may be stored in non-volatile memory. When executed by the processor(s) 1700, the remote terminal unit(s) 1716 may implement the various functionalities and features associated with the fatigue analysis controller 16 described herein.

As desired, embodiments of the disclosure may include a fatigue analysis controller 16 with more or fewer components than are illustrated in FIG. 17. Additionally, certain components of the example fatigue analysis controller 16 shown in FIG. 17 may be combined in various embodiments of the disclosure. The fatigue analysis controller 16 of FIG. 17 is provided by way of example only.

References are made to systems, methods, apparatuses, and computer program products according to example embodiments. It will be understood that at least some of the systems, methods, apparatuses, and computer program products, may be implemented at least partially by computer program instructions. These computer program instructions may be loaded onto a general purpose computer, special purpose computer, special purpose hardware-based computer, or other programmable data processing apparatus to produce a machine, such that the instructions which execute on the computer or other programmable data processing apparatus create means for implementing the functionality of at least some of the systems, methods, apparatuses, and computer program products discussed.

These computer program instructions may also be stored in a non-transitory computer-readable memory that may direct a computer or other programmable data processing apparatus to function in a particular manner, such that the instructions stored in the computer-readable memory produce an article of manufacture including instruction means that implement the function specified. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide task, acts, actions, or operations for implementing the functions specified.

One or more components of the systems and one or more elements of the methods described herein may be implemented through an application program running on an operating system of a computer. They may also be practiced with other computer system configurations, including hand-held devices, multiprocessor systems, microprocessor-based or programmable consumer electronics, mini-computers, mainframe computers, and the like.

Application programs that are components of the systems and methods described herein may include routines, programs, components, data structures, etc. that may implement certain abstract data types and perform certain tasks or actions. In a distributed computing environment, the application program (in whole or in part) may be located in local memory or in other storage. In addition, or alternatively, the application program (in whole or in part) may be located in remote memory or in storage to allow for circumstances where tasks can be performed by remote processing devices linked through a communications network.

Having now described some illustrative embodiments of the disclosure, it should be apparent to those skilled in the art that the foregoing is merely illustrative and not limiting, having been presented by way of example only. Numerous modifications and other embodiments are within the scope of one of ordinary skill in the art and are contemplated as falling within the scope of the disclosure. In particular, although many of the examples presented herein involve specific combinations of method acts or system elements, it should be understood that those acts and those elements may be combined in other ways to accomplish the same objectives. Those skilled in the art should appreciate that the parameters and configurations described herein are exemplary and that actual parameters and/or configurations will depend on the specific application in which the systems, methods, and/or aspects or techniques of the disclosure are used. Those skilled in the art should also recognize or be able to ascertain, using no more than routine experimentation, equivalents to the specific embodiments of the disclosure. It is, therefore, to be understood that the embodiments described herein are presented by way of example only and that, within the scope of any appended claims and equivalents thereto, the disclosure may be practiced other than as specifically described.

This application is a PCT of U.S. Provisional Application No. 63/443,351, filed Feb. 3, 2023, titled “SYSTEMS, APPARATUSES, CONTROLLERS, AND METHODS PROVIDING ENHANCED FATIGUE STRENGTH ANALYSIS,” and U.S. Provisional Application No. 63/492,064, filed Mar. 24, 2023, titled “SYSTEMS, APPARATUSES, CONTROLLERS, AND METHODS PROVIDING ENHANCED FATIGUE STRENGTH ANALYSIS,” the disclosures of all of which are incorporated herein by reference in their entireties.

Furthermore, the scope of the present disclosure shall be construed to cover various modifications, combinations, additions, alterations, etc., above and to the above-described embodiments, which shall be considered to be within the scope of this disclosure. Accordingly, various features and characteristics as discussed herein may be selectively interchanged and applied to other illustrated and non-illustrated embodiment, and numerous variations, modifications, and additions further may be made thereto without departing from the spirit and scope of the present disclosure as set forth in the appended claims.

What is claimed is:

1. A method to enhance prediction of fatigue strength associated with a component, the method comprising:
determining a first localized load measure tensor associated with a first fatigue-relevant instant in time and a portion of the component, the first localized load measure tensor having a first tensor invariant;
determining a second localized load measure tensor associated with a second fatigue-relevant instant in time and the portion of the component, the second localized load measure tensor having a second tensor invariant, one of the first localized load measure tensor or the second localized load measure tensor having a third tensor invariant, the third tensor invariant being non-collinear relative to one of the first tensor invariant or the second tensor invariant of the one of the first localized load measure tensor or the second localized load measure tensor, and the first localized load measure tensor and the second localized load measure tensor being determined at an orientation relative to a coordinate system;
determining a first fatigue strength, the first fatigue strength being a single-load-mode fatigue strength and having a first loading mode, a first load ratio, and a first life associated with the portion of the component;
determining a second fatigue strength, the second fatigue strength being a single-load-mode fatigue strength and having a second loading mode, a second load ratio, and second life associated with the portion of the component;
determining a third fatigue strength, the third fatigue strength being a single-load-mode fatigue strength and having a third loading mode, a third load ratio, and a third life associated with the portion of the component; and
determining, via a fatigue strength analyzer and based at least in part on the first tensor invariant, the second tensor invariant, the third tensor invariant, the first fatigue strength, the second fatigue strength, and the third fatigue strength, an equivalent localized load measure associated with the portion of the component, such that the equivalent localized load measure is substantially independent of the orientation relative to the coordinate system.

2. The method of claim 1, wherein the first tensor invariant, the second tensor invariant, and the third tensor invariant are independent of one another.

3. The method of claim 1, wherein the first loading mode comprises a first uniaxial load, the second loading mode comprises a first torsional load, and the third loading mode comprises one of a second uniaxial load or a second torsional load.

4. The method of claim 3, wherein one or more of:
(a) the third loading mode comprises a second uniaxial load associated with the portion of the component, the second uniaxial load having a second uniaxial load ratio different than the first load ratio; or
(b) the third loading mode comprises a second torsional load associated with the portion of the component, the second torsional load having a second torsional load ratio different than the first torsional load ratio.

5. The method of claim 1, wherein one or more of:
(a) the coordinate system comprises one of a three-dimensional coordinate system, a localized load measure-based coordinate system, a cartesian coordinate system, a cylindrical coordinate, or a spherical coordinate system; or
(b) one or more of the first life, the second life, or the third life comprises a number of load cycles or a time period.

6. The method of claim 1, wherein one of the first tensor invariant or the second tensor invariant is indicative of one or more of (a) von Mises stress; (b) a second invariant of a deviatoric stress tensor; or (c) octahedral shear stress.

7. The method of claim 6, wherein one or more of the first tensor invariant or the second tensor invariant is indicative of one or more of (a) a first invariant of a stress tensor or (b) hydrostatic stress.

8. The method of claim 1, further comprising one or more of:
(a) determining, based at least in part on the first localized load measure tensor and the second localized load measure tensor, an equivalent mean localized load measure tensor;
(b) determining, based at least in part on the first localized load measure tensor and the second localized load measure tensor, an equivalent alternating localized load measure tensor;
(c) determining, based at least in part on the equivalent mean localized load measure tensor and the equivalent alternating localized load measure tensor, an equivalent mean octahedral shear localized load measure;
(d) determining, based at least in part on the equivalent mean localized load measure tensor and the equivalent alternating localized load measure tensor, an equivalent alternating octahedral shear localized load measure;
(e) determining, based at least in part on the equivalent mean localized load measure tensor and the equivalent alternating localized load measure tensor, an equivalent mean hydrostatic localized load measure; or
(f) determining, based at least in part on the equivalent mean localized load measure tensor and the equivalent alternating localized load measure tensor, an equivalent alternating hydrostatic localized load measure.

9. The method of claim 8, further comprising:
determining an equivalent mean localized load measure based at least in part on the equivalent mean octahedral shear localized load measure and the equivalent mean hydrostatic localized load measure;
determining an equivalent alternating load measure based at least in part on the equivalent alternating octahedral shear localized load measure and the equivalent alternating hydrostatic localized load measure; and
determining the equivalent localized load measure associated with the portion of the component based at least in part on one or more of the equivalent mean localized load measure and the equivalent alternating load measure.

10. The method of claim 1, further comprising modifying the equivalent localized load measure via analysis using one or more of: (a) a critical-plane-theory-based fatigue analysis method; (b) an integral-based fatigue analysis method; (c) a rectangular hull-related fatigue analysis method; (d) a minimum circumscribed sphere-related fatigue analysis method; or (e) a minimum circumscribed ellipsoid-related fatigue analysis method.

11. A fatigue strength analyzer for enhancing prediction of a fatigue strength associated with a component, the fatigue strength analyzer comprising:
a fatigue analysis controller configured to:
receive a first localized load measure tensor signal indicative of a first localized load measure tensor associated with a first fatigue-relevant instant in time and a portion of the component, the first localized load measure tensor having a first tensor invariant;
receive a second localized load measure tensor signal indicative of a second localized load measure tensor associated with a second fatigue-relevant instant in time and the portion of the component, the second localized load measure tensor having a second tensor invariant, one of the first localized load measure tensor or the second localized load measure tensor having a third tensor invariant, the third tensor invariant being non-collinear relative to one of the first tensor invariant or the second tensor invariant of the one of the first localized load measure tensor or the second localized load measure tensor, and the first localized load measure tensor and the second localized load measure tensor being determined at an orientation relative to a coordinate system;
determine a first fatigue strength, the first fatigue strength being a single-load-mode fatigue strength and having a first loading mode, a first load ratio, and a first life associated with the portion of the component;
determine a second fatigue strength, the second fatigue strength being a single-load-mode fatigue strength and having a second loading mode, a second load ratio, and second life associated with the portion of the component;
determine a third fatigue strength, the third fatigue strength being a single-load-mode fatigue strength and having a third loading mode, a third load ratio, and a third life associated with the portion of the component; and
determine, based at least in part on the first tensor invariant, the second tensor invariant, the third tensor invariant, the first fatigue strength, the second fatigue strength, and the third fatigue strength, an equivalent localized load measure associated with the portion of the component, such that the equivalent localized load measure is substantially independent of the orientation relative to the coordinate system.

12. The fatigue strength analyzer of claim 11, wherein one or more of:
(a) the first tensor invariant, the second tensor invariant, and the third tensor invariant are independent of one another; or
(b) the first loading mode comprises a first uniaxial load, the second loading mode comprises a first torsional load, and the third loading mode comprises one of a second uniaxial load or second a torsional load.

13. The fatigue strength analyzer of claim 11, wherein the first loading mode comprises a first uniaxial load, the second loading mode comprises a first torsional load, and the third loading mode comprises one of a second uniaxial load or second a torsional load; and
one or more of:
(a) the third loading mode comprises a second uniaxial load associated with the portion of the component, the second uniaxial load having a second uniaxial load ratio different than the first load ratio; or
(b) the third loading mode comprises a second torsional load associated with the portion of the component, the second torsional load having a second torsional load ratio different than the first torsional load ratio.

14. The fatigue strength analyzer of claim 11, wherein one or more of:
(a) the coordinate system comprises one of a three-dimensional coordinate system, a localized load measure-based coordinate system, a cartesian coordinate system, a cylindrical coordinate, or a spherical coordinate system; or
(b) one or more of the first life, the second life, or the third life comprises a number of load cycles or a time period.

15. The fatigue strength analyzer of claim 11, wherein one of the first tensor invariant or the second tensor invariant is indicative of one or more of (a) von Mises stress; (b) a second invariant of a deviatoric stress tensor; or (c) octahedral shear stress.

16. The fatigue strength analyzer of claim 15, wherein one or more of the first tensor invariant or the second tensor invariant is indicative of one or more of (a) a first invariant of a stress tensor or (b) hydrostatic stress.

17. The fatigue strength analyzer of claim 11, wherein the fatigue analysis controller is further configured to one or more of:
(a) determine, based at least in part on the first localized load measure tensor and the second localized load measure tensor, an equivalent mean localized load measure tensor;
(b) determine, based at least in part on the first localized load measure tensor and the second localized load measure tensor, an equivalent alternating localized load measure tensor;
(c) determine, based at least in part on the equivalent mean localized load measure tensor and the equivalent alternating localized load measure tensor, an equivalent mean octahedral shear localized load measure;
(d) determine, based at least in part on the equivalent mean localized load measure tensor and the equivalent alternating localized load measure tensor, an equivalent alternating octahedral shear localized load measure;
(e) determine, based at least in part on the equivalent mean localized load measure tensor and the equivalent alternating localized load measure tensor, an equivalent mean hydrostatic localized load measure; or
(f) determine, based at least in part on the equivalent mean localized load measure tensor and the equivalent alternating localized load measure tensor, an equivalent alternating hydrostatic localized load measure.

18. The fatigue strength analyzer of claim 17, wherein the fatigue analysis controller is further configured to:
determine an equivalent mean localized load measure based at least in part on the equivalent mean octahedral shear localized load measure and the equivalent mean hydrostatic localized load measure;
determine an equivalent alternating load measure based at least in part on the equivalent alternating octahedral shear localized load measure and the equivalent alternating hydrostatic localized load measure; and
determine the equivalent localized load measure associated with the portion of the component based at least in part on one or more of the equivalent mean localized load measure and the equivalent alternating load measure.

19. The fatigue strength analyzer of claim 11, wherein the fatigue analysis controller is further configured to modify the equivalent localized load measure via analysis using one or more of: (a) a critical-plane-theory-based fatigue analysis method; (b) an integral-based fatigue analysis method; (c) a rectangular hull-related fatigue analysis method; (d) a minimum circumscribed sphere-related fatigue analysis method; or (e) a minimum circumscribed ellipsoid-related fatigue analysis method.

20. An oilfield operational component comprising:
a component geometry; and
a component material having a material fatigue limit and forming the component geometry, the oilfield operational component being configured such that when subjected to cyclic loading the oilfield operational component has an equivalent localized load measure less than or equal to the material fatigue limit, the equivalent localized load measure being determined according to a fatigue strength model configured to:
receive a first localized load measure tensor signal indicative of a first localized load measure tensor associated with a first fatigue-relevant instant in time and a portion of the component, the first localized load measure tensor having a first tensor invariant;
receive a second localized load measure tensor signal indicative of a second localized load measure tensor associated with a second fatigue-relevant instant in time and the portion of the component, the second localized load measure tensor having a second tensor invariant, one of the first localized load measure tensor or the second localized load measure tensor having a third tensor invariant, the third tensor invariant being non-collinear relative to one of the first tensor invariant or the second tensor invariant of the one of the first localized load measure tensor or the second localized load measure tensor, and the first localized load measure tensor and the second localized load measure tensor being determined at an orientation relative to a coordinate system;
determine a first fatigue strength, the first fatigue strength being a single-load-mode fatigue strength and having a first loading mode, a first load ratio, and a first life associated with the portion of the component;
determine a second fatigue strength, the second fatigue strength being a single-load-mode fatigue strength and having a second loading mode, a second load ratio, and second life associated with the portion of the component;
determine a third fatigue strength, the third fatigue strength being a single-load-mode fatigue strength and having a third loading mode, a third load ratio, and a third life associated with the portion of the component; and
determine, based at least in part on the first tensor invariant, the second tensor invariant, the third tensor invariant, the first fatigue strength, the second fatigue strength, and the third fatigue strength, an equivalent localized load measure associated with the portion of the component, such that the equivalent localized load measure is substantially independent of the orientation relative to the coordinate system.

21. The oilfield operational component of claim 20, wherein the oilfield operational component comprises one of a fluid manifold, a fluid conduit, a connector, a fluid end block, a power end frame, a crankshaft, a connecting rod, a plunger, a valve body, a valve seat, or a stud.

22. A system for enhancing prediction of fatigue strength associated with a component, the system comprising:
at least one processor configured to cause execution of a fatigue strength model configured to predict the fatigue strength of the component, the fatigue strength model being configured to:
receive a first localized load measure tensor signal indicative of a first localized load measure tensor associated with a first fatigue-relevant instant in time and a portion of the component, the first localized load measure tensor having a first tensor invariant;
receive a second localized load measure tensor signal indicative of a second localized load measure tensor associated with a second fatigue-relevant instant in time and the portion of the component, the second localized load measure tensor having a second tensor invariant, one of the first localized load measure tensor or the second localized load measure tensor having a third tensor invariant, the third tensor invariant being non-collinear relative to one of the first tensor invariant or the second tensor invariant of the one of the first localized load measure tensor or the second localized load measure tensor, and the first localized load measure tensor and the second localized load measure tensor being determined at an orientation relative to a coordinate system;
determine a first fatigue strength, the first fatigue strength being a single-load-mode fatigue strength and having a first loading mode, a first load ratio, and a first life associated with the portion of the component;
determine a second fatigue strength, the second fatigue strength being a single-load-mode fatigue strength and having a second loading mode, a second load ratio, and second life associated with the portion of the component;
determine a third fatigue strength, the third fatigue strength being a single-load-mode fatigue strength and having a third loading mode, a third load ratio, and a third life associated with the portion of the component; and
determine, based at least in part on the first tensor invariant, the second tensor invariant, the third tensor invariant, the first fatigue strength, the second fatigue strength, and the third fatigue strength, an equivalent localized load measure associated with the portion of the component, such that the equivalent localized load measure is substantially independent of the orientation relative to the coordinate system.

23. The system of claim 22, wherein one or more of:
(a) the first tensor invariant, the second tensor invariant, and the third tensor invariant are independent of one another; or
(b) the first loading mode comprises a first uniaxial load, the second loading mode comprises a first torsional load, and the third loading mode comprises one of a second uniaxial load or second a torsional load.

24. The system of claim 22, wherein the first loading mode comprises a first uniaxial load, the second loading mode comprises a first torsional load, and the third loading mode comprises one of a second uniaxial load or second a torsional load; and
one or more of:
(a) the third loading mode comprises a second uniaxial load associated with the portion of the component, the second uniaxial load having a second uniaxial load ratio different than the first load ratio; or
(b) the third loading mode comprises a second torsional load associated with the portion of the component, the second torsional load having a second torsional load ratio different than the first torsional load ratio.

25. The system of claim 22, wherein one or more of:
(a) the coordinate system comprises one of a three-dimensional coordinate system, a localized load measure-based coordinate system, a cartesian coordinate system, a cylindrical coordinate, or a spherical coordinate system; or
(b) one or more of the first life, the second life, or the third life comprises a number of load cycles or a time period.

26. The system of claim 22, wherein one of the first tensor invariant or the second tensor invariant is indicative of one or more of (a) von Mises stress; (b) a second invariant of a deviatoric stress tensor; or (c) octahedral shear stress.

27. The system of claim 26, wherein one or more of the first tensor invariant or the second tensor invariant is indicative of one or more of (a) a first invariant of a stress tensor or (b) hydrostatic stress.

28. The system of claim 22, wherein the fatigue strength model is further configured to:
(a) determine, based at least in part on the first localized load measure tensor and the second localized load measure tensor, an equivalent mean localized load measure tensor;
(b) determine, based at least in part on the first localized load measure tensor and the second localized load measure tensor, an equivalent alternating localized load measure tensor;
(c) determine, based at least in part on the equivalent mean localized load measure tensor and the equivalent alternating localized load measure tensor, an equivalent mean octahedral shear localized load measure;
(d) determine, based at least in part on the equivalent mean localized load measure tensor and the equivalent alternating localized load measure tensor, an equivalent alternating octahedral shear localized load measure;
(e) determine, based at least in part on the equivalent mean localized load measure tensor and the equivalent alternating localized load measure tensor, an equivalent mean hydrostatic localized load measure; or
(f) determine, based at least in part on the equivalent mean localized load measure tensor and the equivalent alternating localized load measure tensor, an equivalent alternating hydrostatic localized load measure.

29. The system of claim 28, wherein the fatigue strength model is further configured to:
determine an equivalent mean localized load measure based at least in part on the equivalent mean octahedral shear localized load measure and the equivalent mean hydrostatic localized load measure;
determine an equivalent alternating load measure based at least in part on the equivalent alternating octahedral shear localized load measure and the equivalent alternating hydrostatic localized load measure; and
determine the equivalent localized load measure associated with the portion of the component based at least in part on one or more of the equivalent mean localized load measure and the equivalent alternating load measure.

30. The system of claim 22, wherein the fatigue strength model is configured to modify the equivalent localized load measure via analysis using one or more of: (a) a critical-plane-theory-based fatigue analysis method; (b) an integral-based fatigue analysis method; (c) a rectangular hull-related fatigue analysis method; (d) a minimum circumscribed sphere-related fatigue analysis method; or (e) a minimum circumscribed ellipsoid-related fatigue analysis method.
